(19) United States
(12) Patent Application Publication
(10) Pub. No.: US 2018/0209869 A1
(43) Pub. Date: Jul. 26, 2018

(54) BEHAVIOR ESTIMATION METHOD FOR FAULT-CROSSING UNDERGROUND PIPELINE AND BEHAVIOR ESTIMATION DEVICE FOR FAULT-CROSSING UNDERGROUND PIPELINE

(71) Applicant: KUBOTA CORPORATION, Osaka-shi (JP)

(72) Inventors: Shozo KISHI, Amagasaki-shi (JP); Keita ODA, Amagasaki-shi (JP)

(73) Assignee: KUBOTA CORPORATION, Osaka-shi (JP)

(21) Appl. No.: 15/916,773

(22) Filed: Mar. 9, 2018

Related U.S. Application Data
(63) Continuation-in-part of application No. PCT/JP2016/076443, filed on Sep. 8, 2016.

(30) Foreign Application Priority Data
Sep. 9, 2015 (JP) 2015-177923

(51) Int. Cl. G01M 5/00; G01L 5/00; F16L 1/036

(52) U.S. Cl. CPC G01M 5/0041; F16L 1/036; G01L 5/00

(57) ABSTRACT

A behavior estimation method includes a first step of calculating number of earthquake resistant joints required for absorbing a fault displacement amount in a pipe orthogonal direction, based on an allowable deflection angle and a pipe effective length, and calculating a deflection range in a pipe axis direction, a second step of calculating a load, received by the pipe due to relative displacement between the pipe and ground corresponding to a ground spring model in the pipe orthogonal direction defined with spring constants respectively for relative displacements smaller and larger than a predetermined relative displacement, a third step of calculating a bending moment distribution of joint positions from a bending moment of a trapezoidal distribution load, and obtaining a pipe deflection angle at each of the joint positions based on a predetermined joint deflection spring model, and a deflection performance evaluation step.

### CROSS-REFERENCE TO RELATED APPLICATIONS

The present application is a continuing application of International Application No. PCT/JP2016/076443 filed on Sep. 8, 2016, which claims priority from Japanese Patent Application No. 2015-177923 filed on Sep. 10, 2015.

### TECHNICAL FIELD

The present invention relates to a behavior estimation method for a fault-crossing underground pipeline and a behavior estimation device for a fault-crossing underground pipeline.

### BACKGROUND ART

A pipeline buried in the ground may be an earthquake resistant joint ductile iron pipe or the like as illustrated in FIG. 1A and FIG. 1B. Such a pipeline includes a plurality of pipes 1 joined to each other via earthquake resistant joints. The pipeline can absorb large ground displacement, due to subsidence or a crack formed in the ground, with a behavior of a joint when an expansion and contraction amount or a deflection angle of an adjacent joint is overwhelmed.

FIG. 1C illustrates an expansion/contraction behavior of a joint of an NS-type (Hereinafter NS) ductile iron pipe as an example of such an earthquake resistant joint ductile iron pipe. An upper section illustrates a normal state, a middle section illustrates a contracted state, and a lower section illustrates an expanded state. In the figure, signs 2, 3, 4, and 5 respectively denote a socket, a spigot, a rubber ring, and a lock ring. The earthquake resistant joint has the following specifications, an expansion and contraction amount: +1% of the pipe length, a pullout strength: 3 DkN (D is a nominal diameter in a unit of mm), an allowable deflection angle α during pipeline construction: 4°, and a maximum allowable deflection angle β: 8°.

Patent Document 1 discloses a maintenance and management method enabling integrity evaluation for unequal settlement for a pipeline including mechanical joints. More specifically, Patent Document 1 proposes a maintenance and management method including: measuring, on the ground surface, a ground subsidence distribution along the pipeline that is buried in the ground and includes the mechanical joint; obtaining a local relative subsidence amount δr and a length L of the subsidence occurred, based on the subsidence distribution; and comparing a maximum deflection angle θmax and an allowable deflection angle of a mechanical joint, within the subsidence occurring range, with the maximum deflection angle θmax satisfying θmax≤2 arctan (2δr/L). With this method, the integrity of the pipeline can be evaluated.

### PRIOR ART DOCUMENT

### Patent Document

[Patent document 1] Japanese Patent Application Publication No. 1995-248100

### SUMMARY OF INVENTION

### Problems to be Solved by the Invention

More simply put, the maintenance and management method for evaluating the integrity of a pipeline described above is a method including: calculating a deflection angle of the mechanical joint based on the ground subsidence distribution measured on the ground surface; and comparing the deflection angle thus calculated with the allowable deflection angle. Through these steps, the integrity of a pipeline that has been buried can be evaluated.

Japan has been regarded as being in an active phase of the earthquake. Thus, importance of the integrity evaluation based on an estimation of a behavior of a fault-crossing underground pipeline has been widely recognized. Still, only practical behavior estimation method currently available is an evaluation method using a dedicated simulation device executing a structural analysis program using a large-scale and time consuming finite element method. Furthermore, there has been a demand for a highly practical behavior estimation method for a fault-crossing underground pipeline, not only effective for evaluation of the pipeline that has been buried but also effective for designing planned pipelines to be laid with enough safety ensured based on estimated behavior of the fault-crossing underground pipeline.

The present invention is made in view of the above tasks, and an object of the present invention is to provide a behavior estimation method for a fault-crossing underground pipeline and a behavior estimation device for a fault-crossing underground pipeline involving no large-scale simulation device and achieving high accuracy with a simple configuration.

### Means for Solving the Problems

To achieve the above-described object, a first characteristic configuration of a behavior estimation method for a fault-crossing underground pipeline is that the method includes:

a first step of calculating a minimum number of earthquake resistant joints N, on one side of a fault surface, required for absorbing a fault displacement amount H in a pipe orthogonal direction, in fault displacement amounts, by using Formula 1, and calculating a deflection range L₀ in a pipe axis direction corresponding to the minimum number of earthquake resistant joints N by using Formula 2, for a pipeline including joints defined with a predetermined joint deflection spring model with a bending moment set to be different values before and after an allowable deflection angle θₐ and pipes having an effective length L,

$$\begin{matrix}\frac{H}{2} ≦ L {\sum }_{k = 1}^{N} sin ( k {θ}_{a} ) & [ Formula 1 ] \\ {L}_{0} = L \times N ; & [ Formula 2 ]\end{matrix}$$

a second step of calculating a load p(y), received by the pipe due to relative displacement y between the pipe and ground, as a trapezoidal distribution load by using Formula 3 corresponding to a ground spring model in the pipe orthogonal direction defined with spring constants k_{1y} and k_{2y} (k_{1y}>k_{2y}) respectively for relative displacements smaller and larger than predetermined relative displacement δ_{gy},

p(y)=k_{2y}y+(k_{1y}−k_{2y})δ_{gy}; [Formula 3]

a third step of calculating a bending moment distribution of joint positions from a bending moment M(x) of the trapezoidal distribution load at a position x in the pipe axis direction by using Formula 4, and obtaining a pipe deflection angle θ at each of the joint positions based on the joint deflection spring model using the bending moment distribution obtained,

$$M ( x ) = \frac{x ( {L}_{0} - x )}{6} \{ 3 p ( 0 ) + ( \frac{2 {L}_{0} - x}{{L}_{0}} ) p ( \frac{H}{2} ) \} ; \qquad [ Formula 4 ]$$

and

a deflection performance evaluation step of evaluating deflection performance based on whether the deflection angle θ, obtained in the third step, does not exceed the allowable deflection angle θₐ.

In the first step, the minimum number of earthquake resistant joints N is obtained by using Formula 1 under an assumption that all of the minimum number of earthquake resistant joints N, on one side of the fault surface, required for absorbing the fault displacement amount H in the pipe orthogonal direction are deflected by the allowable deflection angle θₐ regardless of the fault displacement amount in the pipe axis direction, and the deflection range L₀ in the pipe axis direction corresponding to the minimum number of earthquake resistant joints N is obtained by using Formula 2.

In the second step, a load p(y) applied to the pipe due to the relative displacement y between the pipe and the ground is calculated as a trapezoidal distribution load by using Formula 3 corresponding to a ground spring model in the predetermined pipe orthogonal direction, under an assumption that relative displacement y between the pipeline and the ground is linearly distributed, with the fault surface at the center.

In the third step, a bending moment distribution at joint positions relative to the trapezoidal distribution load is obtained by using Formula 4. Then, a pipe deflection angle θ at each joint position is obtained by using a joint deflection spring model. In the deflection performance evaluation step, deflection resistance performance is evaluated based on whether the deflection angle θ obtained in the third step does not exceed the allowable deflection angle θₐ. Thus, the deflection resistance performance is evaluated only based on the fault displacement amount H in the pipe orthogonal direction, for various fault displacements with different fault displacement amounts in the pipe axis direction.

A second characteristic configuration of the method is that the method further includes:

a fourth step of calculating axial force f(y) by using Formula 7 corresponding to the ground spring model in the pipe axis direction defined with spring constants k₁ and k₂ (k₁>k₂) respectively for relative displacements smaller and larger than predetermined relative displacement δ_{g}, based on a relative displacement amount X_{g} between the pipe and the ground at a fault surface corresponding to a half value of a fault displacement amount in the pipe axis direction, in the fault displacement amounts, a joint expansion and contraction amount δ, a relative displacement amount y(x), between the pipe and the ground at the position x in the pipe axis direction relative to the fault surface, defined with Formula 5, and a range of influence X, in the pipe axis direction, defined by Formula 6,

$$\begin{matrix}y ( x ) = - \frac{δ}{L - δ} x + {X}_{g} , & [ Formula 5 ] \\ X = \frac{L - δ}{δ} {X}_{g} , and & [ Formula 6 ] \\ f ( y ) = {k}_{2} y + ( {k}_{1} - {k}_{2} ) {δ}_{g} ; & [ Formula 7 ]\end{matrix}$$

a fifth step of calculating axial force fₘₐₓ at a fault position by using Formula 8,

$$\begin{matrix}{f}_{max} = {\int }_{0}^{X} f ( y ( x ) ) dx \\ = \frac{{k}_{2} ( L - δ )}{2 δ} {X}_{g}^{2} + \frac{{δ}_{g} ( {k}_{1} - {k}_{2} ) ( L - δ )}{δ} {X}_{g} ;\end{matrix} \qquad [ Formula 8 ]$$

an axial force evaluation step of evaluating the axial force based on whether the axial force fₘₐₓ obtained in the fifth step does not exceed a predetermined reference value.

In the fourth step, the axial force f(y) is calculated by using Formula 7 corresponding to the ground spring model in the pipe axis direction. In the fifth step, the axial force fₘₐₓ is calculated by integrating the axial forces f(y) within the range of influence X in the pipe axis direction from the fault surface.

Then, in the axial force evaluation step, the axial force is evaluated based on whether the axial force fₘₐₓ does not exceed a predetermined reference value. Thus, axial force resistance performance is evaluated for various fault displacements with different fault displacement amounts in the pipe orthogonal direction, only by using a fault displacement amount X_{g} in the pipe axis direction.

A third characteristic configuration of the method is that the method further includes:

a sixth step of setting, when the axial force fₘₐₓ is evaluated to exceed the predetermined reference value in the axial force evaluation step, an arranged position of each of large displacement absorption units with a joint expansion and contraction amount Δ, the arranged position being a position where the deflection angle θ obtained in the third step does not exceed a predetermined angle threshold θₜ;

a seventh step of calculating the axial force fₘₐₓ by using Formula 10 for the range of influence X, in the pipe axis direction, defined by Formula 9 based on a disposed interval s of the large displacement absorption units, number N_{g} of the large displacement absorption units within the range of influence in the pipe axis direction, and number n₁ of joints between the fault surface and one of the large displacement absorption units closest to the fault surface,

$$\begin{matrix}X = max ( \frac{L - δ}{δ} ( {X}_{g} - {N}_{g} Δ ) , {n}_{1} ( L - δ ) + ( {N}_{g} - 1 ) n ( L - δ ) ) \\ {N}_{g} = ⌈ \frac{{X}_{g} - {n}_{1} δ}{n δ + Δ} ⌉ , {n}_{1} = ⌈ ( n + 1 ) / 2 ⌉ , n = s / L & [ Formula 9 ] \\ {f}_{max} = {f}_{ab} - {f}_{b} \\ {f}_{ab} = - \frac{{k}_{2} δ}{2 ( L - δ )} {X}^{2} + \{ {δ}_{g} ( {k}_{1} - {k}_{2} ) + {k}_{2} {X}_{g} \} X \\ {f}_{b} = max ( 0 , \frac{{N}_{g} ( {N}_{g} - 1 )}{2} {f}_{b 1} ) + {f}_{b 2} {N}_{g} \\ {f}_{b 1} = \{ {k}_{2} Δ + {δ}_{g} ( {k}_{1} - {k}_{2} ) \} n ( L - δ ) \\ {f}_{b 2} = {f}_{b 1} \frac{X - {X}_{1}}{n ( L - δ )} ; and \\ {X}_{1} = {n}_{1} ( L - δ ) + ( {N}_{g} - 1 ) n ( L - δ ) & [ Formula 10 ]\end{matrix}$$

a large displacement absorption unit absorbing axial force evaluation step of evaluating the axial force based on whether the axial force fₘₐₓ obtained in the seventh step does not exceed a predetermined reference value.

When the axial force fₘₐₓ is evaluated to exceed the predetermined reference value in the axial force evaluation step described above, the sixth step is performed. In the sixth step, a position where the deflection angle θ, obtained in the third step, does not exceed a predetermined angle threshold θₜ is determined as an arranged position of the large displacement absorption unit with a joint expansion and contraction amount Δ. In the seventh step, the axial force fₘₐₓ for the range of influence X in the pipe axis direction defined by Formula 9, is calculated by using Formula 10. In the large displacement absorption unit absorbing axial force evaluation step, the axial force resistance performance is evaluated based on whether the axial force fₘₐₓ obtained in the seventh step does not exceed a predetermined reference value.

A fourth characteristic configuration of the method is that the method further includes:

an axial stress calculation step of calculating axial stress σₐ=fₘₐₓ/A based on the axial force fₘₐₓ and a pipe cross-sectional area A;

a bending stress calculation step of calculating bending stress σ_{b}=M/Z based on the bending moment M and a pipe section modulus Z;

a stress calculation step of calculating stress σ=σₐ+σ_{b} by adding the axial stress σₐ obtained in the axial stress calculation step and the bending stress σ_{b} obtained in the bending stress calculation step; and a stress evaluation step of evaluating the stress based on whether the stress a obtained in the stress calculation step does not exceed a predetermined resistance.

In the stress evaluation step, whether the stress does not exceed an allowable value is evaluated. The stress is obtained as the sum of the axial stress σₐ, calculated from the axial force fₘₐₓ and the pipe cross-sectional area A, and the bending stress σ_{b}, calculated from the bending moment M and the pipe section modulus Z.

A fifth characteristic configuration of a behavior estimation method for a fault-crossing underground pipeline according to the present invention is that the method includes:

a simple analysis executing step of executing the behavior estimation method for a fault-crossing underground pipeline having any one of the first to fourth characteristic configurations; and

a detailed analysis executing step of executing a structural analysis method employing a finite element method after predetermined evaluation is obtained by the simple analysis executing step.

A behavior estimation method for a fault-crossing underground pipeline having any one of the first to fourth characteristic configurations that can be repeatedly implemented in a short period of time is performed. Then, the desired analysis result thus obtained is subjected to analysis employing a structural analysis method using a finite element method. Thus, sufficiently reliable analysis can be implemented. Furthermore, the number of times the structural analysis employing the time consuming finite element method is repeated can be largely reduced. Thus, an environment for swifter evaluation operation can be achieved.

A characteristic configuration of a behavior estimation device for a fault-crossing underground pipeline according to the present invention is that the device includes:

a behavior estimation calculation unit that executes the behavior estimation method for a fault-crossing underground pipeline according to any one of the first to fourth characteristic configurations;

a condition input unit with which a calculation condition is set for the behavior estimation calculation unit;

a storage unit that stores calculation results obtained by the behavior estimation calculation unit; and

a display unit that displays any one of the calculation results stored in the storage unit.

With the behavior estimation device for a fault-crossing underground pipeline having the configuration described above, evaluation with a certain level of reliability can be performed within a short period of time without performing simulation calculation employing the finite element method requiring long calculation time. Thus, the earthquake resistance of the pipeline that has been buried can be evaluated, and a pipeline that is planned to be buried with high earthquake resistance can be designed.

### Effects of Invention

As described above, the present invention can provide a behavior estimation method for a fault-crossing underground pipeline and a behavior estimation device for a fault-crossing underground pipeline involving no large-scale simulation device and achieving high accuracy with a simple configuration.

### BRIEF DESCRIPTION OF DRAWINGS

FIG. 1A is a diagram illustrating a behavior of a pipeline, including pipes joined to each other with earthquake resistant joints, at the time of ground subsidence. FIG. 1B is a diagram illustrating behavior at the time of cracking in the ground. FIG. 1C is a diagram illustrating an expansion/contraction operation of the earthquake resistant joint.

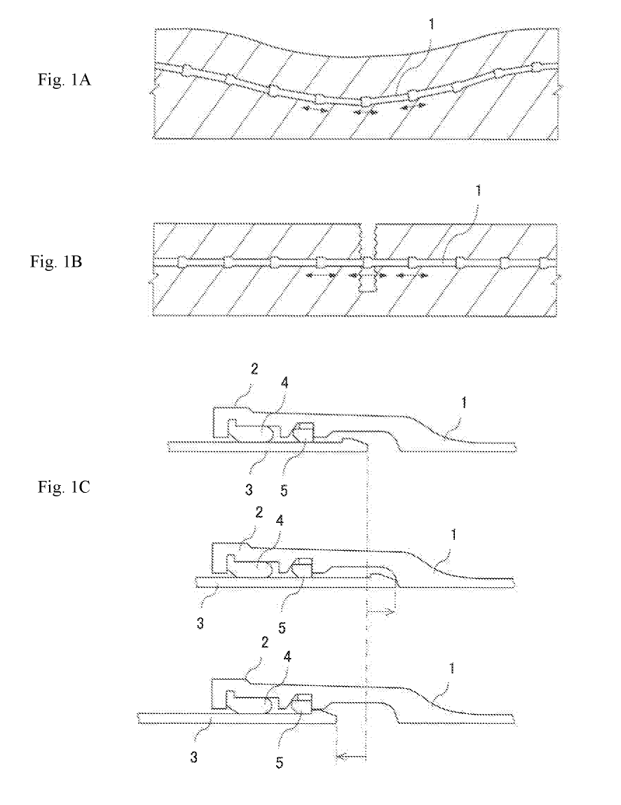

FIG. 2 is a diagram illustrating axial force applied from a fault to the pipeline and a joint deflection angle.

FIG. 3A is a diagram illustrating a joint spring and a ground spring. FIG. 3B to FIG. 3D are each a diagram illustrating a joint spring model. FIG. 3E and FIG. 3F are each a diagram illustrating characteristics of a ground spring model.

FIG. 4 is a diagram illustrating a result of simulation indicating how joints deflect starting from the one close to the fault.

FIG. 5A is a diagram illustrating a joint deflection spring model used for a behavior estimation method based on a joint deflection angle. FIG. 5B is a diagram illustrating a deflection range L₀ of pipes in the pipeline relative to fault displacement H.

FIG. 6A is a diagram illustrating a ground spring model in a pipe orthogonal direction used in the behavior estimation method based on the joint deflection angle. FIG. 6B is a diagram illustrating a distribution of relative displacement y between the pipeline and the ground. FIG. 6C is a diagram illustrating a distribution of a load p(y) applied to the pipeline.

FIG. 7A is a diagram illustrating a joint deflection spring representing an estimation result obtained by a behavior estimation method according to the present invention. FIG. 7B is a diagram illustrating a distribution of joint deflection angles, indicating a result of comparing the estimation results obtained by the behavior estimation method according to the present invention and results obtained by an FEM analysis.

FIG. 8 is a diagram illustrating results of the FEM analysis indicating that axial force-pipe axis direction ground displacement curves, corresponding to different fault intersecting angles, match.

FIG. 9A is a diagram illustrating a state where a joint is contracted due to fault displacement. FIG. 9B is a diagram illustrating relative displacement between the ground and the pipe, in a symmetrical manner relative to the fault surface. FIG. 9C is a diagram illustrating an axial force distribution per unit length.

FIG. 10A is a diagram illustrating a relative displacement amount y(x) between the pipe and the ground. FIG. 10B is a diagram illustrating a pipe axis direction ground spring model used for axial force estimation. FIG. 10C is a diagram illustrating a deflection angle distribution of the joint.

FIG. 11 is a diagram illustrating characteristics of the axial force, as a result of comparison between the estimation result obtained by the behavior estimation method according to the present invention and the result of the FEM analysis.

FIG. 12A is a diagram illustrating a relative displacement amount y(x) between the pipe and the ground in a case where a large displacement absorption unit is used. FIG. 12B is a diagram illustrating a range of influence X of the axial force.

FIG. 13A and FIG. 13B are each a diagram illustrating a calculation method for the range of influence X of the axial force.

FIG. 14 is a diagram illustrating characteristics of the axial force as a result of comparison between the estimation result obtained by the behavior estimation method according to the present invention and the result of the FEM analysis, in the case where the large displacement absorption unit is used.

FIG. 15 is a functional block diagram illustrating a behavior estimation device for a fault-crossing underground pipeline.

FIG. 16 is a diagram illustrating an analysis condition input screen of the behavior estimation device for a fault-crossing underground pipeline.

FIG. 17 is a diagram illustrating an analysis result display screen of the behavior estimation device for a fault-crossing underground pipeline. The left section in the figure illustrates a display screen for a total evaluation result. The right section in the figure illustrates a display screen for an axial force evaluation result for a pipeline including pipes only and an axial force evaluation result for a pipeline including the large displacement absorption unit

FIG. 18 is a diagram illustrating an analysis result display screen of the behavior estimation device for a fault-crossing underground pipeline. The left section in the figure illustrates a display screen for a deflection angle evaluation result. The right section in the figure illustrates a display screen for a stress evaluation result.

FIG. 19 is a flowchart illustrating a flow of the behavior estimation method for a fault-crossing underground pipeline.

### EMBODIMENTS FOR CARRYING OUT THE INVENTION

A behavior estimation method for a fault-crossing underground pipeline and a behavior estimation device for a fault-crossing underground pipeline according to the present invention are described below, with an NS ductile iron pipe described as an example of an earthquake resistant joint ductile iron pipe. One long pipeline including a plurality of pipes is formed with a spigot on one end of each of the pipes inserted in a socket of adjacent one of the pipes via a retainer mechanism. The present invention is not limited to the NS ductile iron pipe, and can be applied to any fault-crossing underground pipeline including a plurality of pipes joined to each other via an earthquake resistant joint.

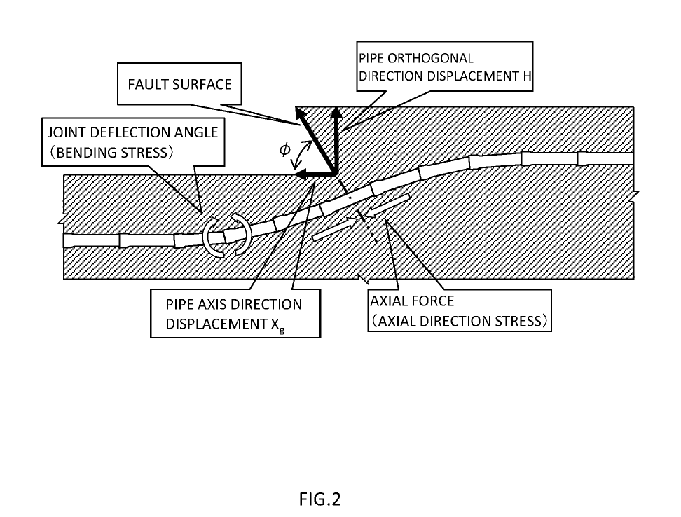

The present invention relates to a method and a device for estimating and evaluating a pipeline behavior against fault displacement, featuring simple calculation of “joint deflection angle”, “axial force”, and “stress” with a fault angle φ of the fault displacement divided into two components in a pipe axis direction and a pipe orthogonal direction, as illustrated in FIG. 2.

The method (device) is implemented based on findings that have been obtained through finite element method (FEM) analysis on a model of a pipeline including joints. This model is obtained with a dedicated simulation device for structural analysis. Thus, the method can be implemented on a general personal computer without using such an expensive dedicated simulation device, whereby the method and the device can achieve high accuracy with a simple configuration. The FEM analysis is a structural analysis employing a finite element method.

Detailed description is given below in order.

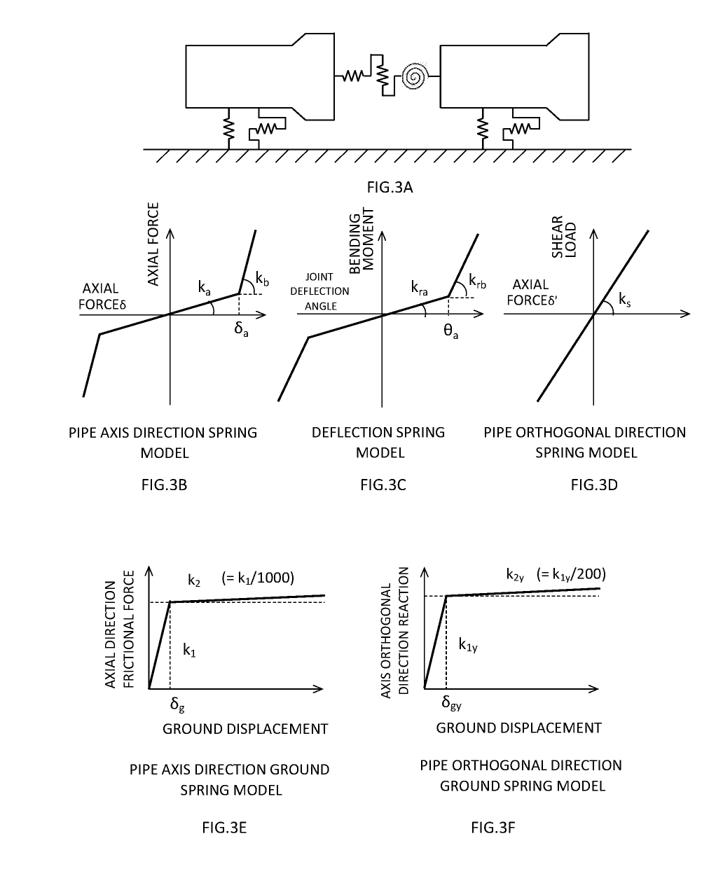

FIG. 3A illustrates joint spring and ground spring models. The models are obtained by modeling joints and the ground based on a spring constant obtained based on an experiment with a pipeline (analysis target), including a plurality of pipes joined to each other via an earthquake resistant joint, treated as a beam (rigid member) on an elastic floor.

FIG. 3B to FIG. 3D illustrate characteristics of the joint spring. FIG. 3E and FIG. 3F illustrate characteristics of the ground spring. A deflection spring, which is one of the joint springs, is set to have an angle (θₐ in FIG. 3C) at which a joint outer surface of a spigot side pipe comes into contact with a joint inner surface of a socket side pipe as a result of deflection between an axis of a pipe with the socket and an axis of a pipe with the spigot, to hinder the deflection. This angle θₐ is referred to as an allowable deflection angle which is uniformly set to 4.0° in the present embodiment.

The NS ductile iron pipe with a nominal diameter 75 to 250 has a maximum deflection angle, by which the pipe is deflectable during the earthquake, set to be 8°. Thus, a joint performance of the pipe is ensured within the range of 8°. The allowable deflection angle and the maximum allowable deflection angle are not limited to values described in the present embodiment, and may vary depending on the nominal diameter or the type of the earthquake resistant joint iron pipe.

An axis direction spring is set to have different spring constants in different ranges including: a range in which the joint expands/contracts due to slipping between the pipe and a rubber ring; and a range in which the expansion/contraction stops due to an effect of the retainer mechanism for the joint.

A pipe axis direction ground spring, which is a part of the ground spring, is configured based on a bilinear model in which the spring constant reduces when the relative displacement between the pipe and the ground exceeds a limit value due to slipping between the pipe and the ground. A pipe orthogonal direction ground spring is configured while taking ground reaction for a downward movement of the pipe relative to the ground, and ground collapse for an upward movement of the pipe relative to the ground into consideration. The configuration of each of the cases is based on the bilinear model in which the spring constant reduces when the relative displacement between the pipe and the ground exceeds the limit value.

The behavior estimation method for a fault-crossing underground pipeline is implemented based on a result of performing the FEM analysis, for a predetermined fault angle and fault displacement, on the joint spring and the ground spring models described above, while changing the fault position and the pipe length. The FEM analysis is performed by using a three-dimensional dynamic nonlinear frame analysis system “DYNA2E” (ITOCHU Techno-Solutions Corporation) that is a dedicated simulation system for executing a structural analysis program.

First of all, an evaluation method for a joint deflection angle due to pipe orthogonal direction ground displacement is described.

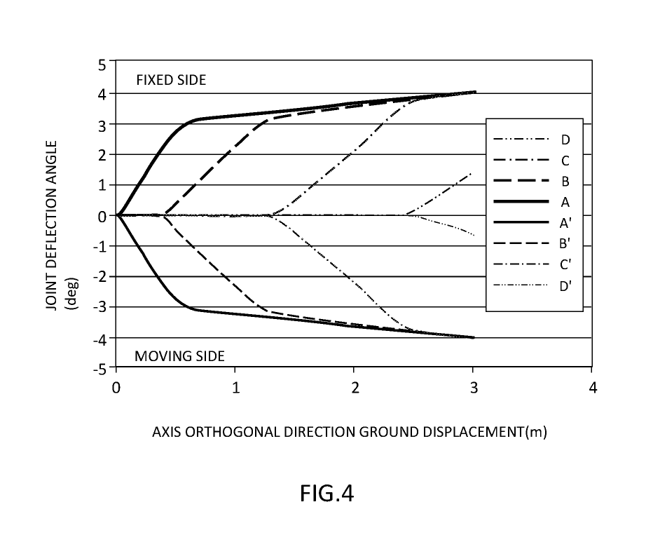

It has been found that the fault displacement is absorbed with the joints sequentially deflected from the fault, when a result of the FEM analysis indicates that the axial force produced in the pipeline is small, as illustrated in FIG. 4.

In FIG. 4, signs A, B, C, and D represent joints that are arranged in this order, on the fixed side of the fault displacement, from a fault surface. Signs A′, B′, C′, and D′ represent joints that are arranged in this order, on the moving side of the fault displacement, from the fault surface.

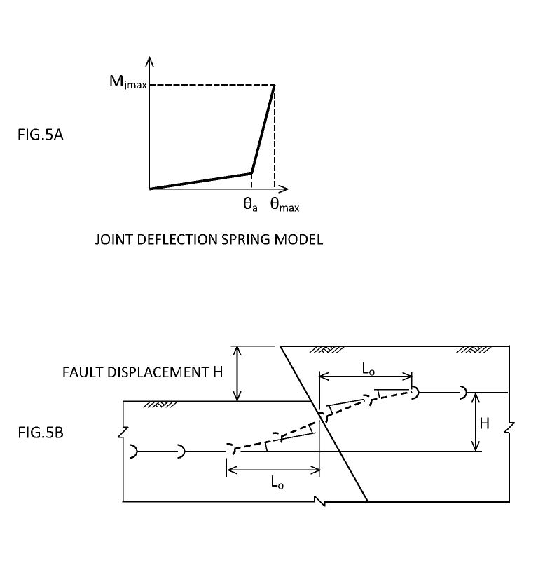

FIG. 5A and FIG. 5B illustrate a first step. In the first step, the minimum number of earthquake resistant joints N, on one side of the fault surface, required for absorbing a fault displacement amount H in the pipe orthogonal direction, in fault displacement amounts, is calculated by using Formula 11 and a deflection range L₀ in the pipe axis direction corresponding to the number of pipes is calculated by using Formula 12 for a pipeline including joints defined with a predetermined joint deflection spring model with a bending moment set to be different values before and after the allowable deflection angle θₐ and pipes having an effective length L,

$$\begin{matrix}\frac{H}{2} ≦ L {\sum }_{k = 1}^{N} sin ( k {θ}_{a} ) & [ Formula 11 ] \\ {L}_{0} = L \times N & [ Formula 12 ]\end{matrix}$$

The first step is performed under an assumption as a result of the FEM analysis that the joint at the fault surface does not deflect and all of the joints in a range of influence of the fault are deflected by the allowable deflection angle θₐ.

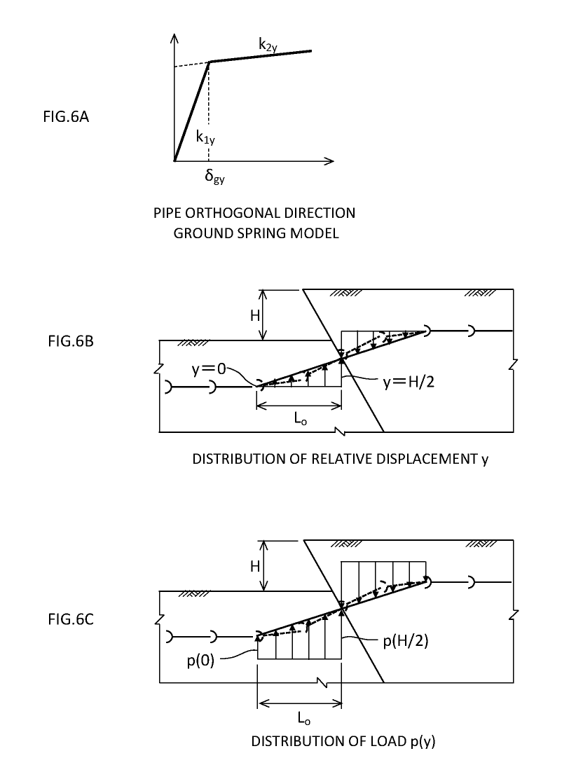

FIG. 6B illustrates an assumed condition for performing a second step described below. Specifically, it is assumed that relative displacement y between the pipeline and the ground is linearly distributed, with the fault surface at the center, so that evaluation indicating safety is obtained. Furthermore, it is assumed that the relative displacement at the fault surface position is H/2, and the relative displacement is 0 at a position separated from the fault surface by La.

In the second step, a load p(y) applied to the pipe due to the relative displacement y between the pipe and the ground is calculated as a trapezoidal distribution load as illustrated in FIG. 6C, by using Formula 13 for a ground spring model, for the pipe orthogonal direction, defined by spring constants k_{1y} and k_{2y} (k_{1y}>k_{2y}) set to be different values respectively for relative displacements smaller and larger than relative displacement δ_{gy} as illustrated in FIG. 6A. In Formula 13, the relative displacement δ_{gy} is extremely small, and thus a value satisfying y≥δ_{gy} is employed so that evaluation indicating safety is obtained also when y<δ_{gy} is satisfied.

p(y)=k_{2y}y+(k_{1y}−k_{2y}) [Formula 13]

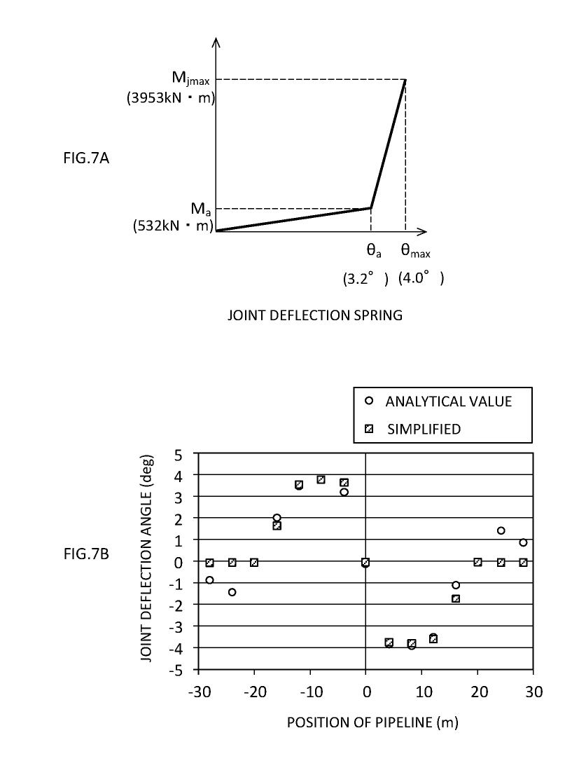

Then, a third step is performed. In this step, a bending moment distribution at joint positions is obtained based on a bending moment M(x) of the trapezoidal distribution load at a position x in the pipe axis direction obtained by using Formula 14. Then, a pipe deflection angle θ at each joint position is obtained by using a joint deflection spring model illustrated in FIG. 7A, based on the bending moment distribution thus obtained.

$$M ( x ) = \frac{x ( {L}_{0} - x )}{6} \{ 3 p ( 0 ) + ( \frac{2 {L}_{0} - x}{{L}_{0}} ) p ( \frac{H}{2} ) \} \qquad [ Formula 14 ]$$

Then, a deflection performance evaluation step is performed. In this step, the deflection performance is evaluated based on whether the deflection angle θ obtained in the third step does not exceed the allowable deflection angle θₐ. Thus, the deflection resistance performance can be evaluated only based on the fault displacement amount H in the pipe orthogonal direction, for various fault displacements with different fault displacement amounts in the pipe axis direction.

FIG. 7B illustrates results (circles in FIG. 7B) of the FEM analysis and results (squares in FIG. 7B) of the analysis according to the present invention. The results indicate that the joint deflection angles close to the fault substantially match between the analyses. This proves the effectiveness of the simple method according to the present invention for evaluating the joint deflection angle.

Next, a simple axial force evaluation method is described.

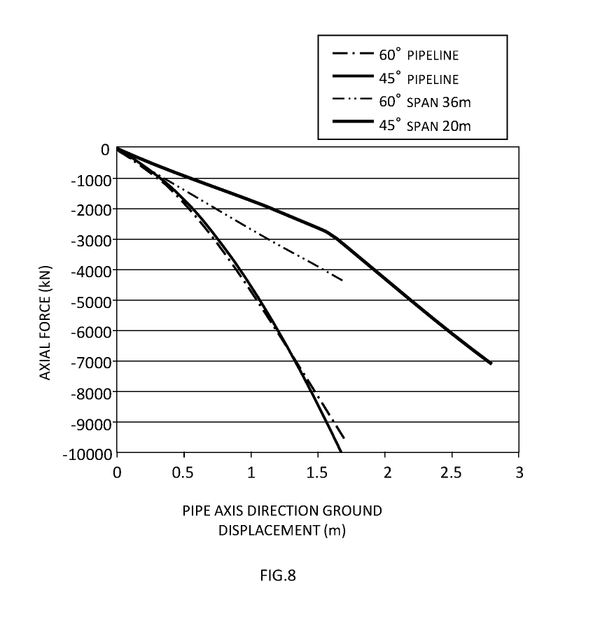

As illustrated in FIG. 8, the results of the FEM analysis indicate that curves of axial force-pipe axis direction ground displacements, with different fault intersecting angle, substantially match. In FIG. 8, the description “pipeline” indicates a pipeline model including pipes only, and the description “span ** m” indicates a pipeline model including large displacement absorption units arranged at a span of ** m.

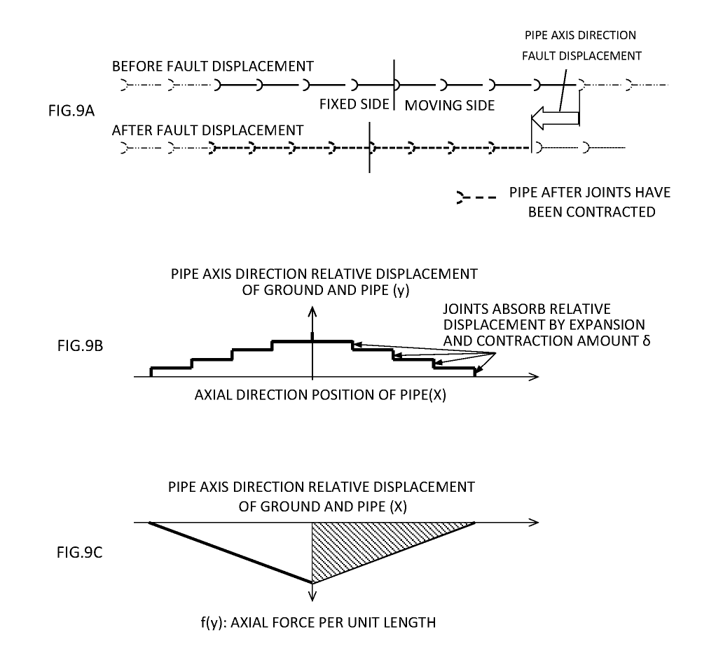

In an upper section of FIG. 9A, a solid line represents the pipeline and the joints before the fault displacement. In a lower section of FIG. 9A, a dotted line represents the pipeline and the joints after the joints have been contracted by the fault displacement. The axial force is obtained as follows under an assumption, based on the findings as a result of the FEM analysis, that the relative displacement, between the ground and the pipe, in the pipe axis direction, is absorbed with the joints contracted as illustrated in FIG. 9B.

As illustrated in FIG. 9C, an axial force f(y) distribution per unit length is obtained by using the ground spring model, and the axial force f(y) is integrated within a hatched range in the figure, whereby axial force fₘₐₓ is obtained.

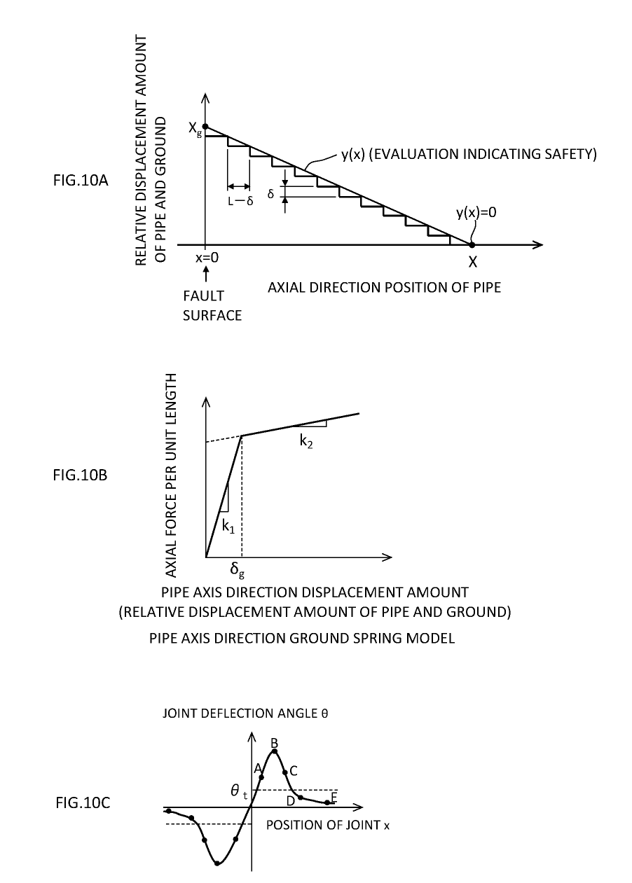

Specifically, FIGS. 10A and 10B illustrate a fourth step. In this step, the axial force f(y) is calculated by using Formula 17 corresponding to the ground spring model in the pipe axis direction defined by spring constants k₁ and k₂ (k₁>k₂) set to be different values respectively for relative displacements smaller and larger than a predetermined relative displacement δ_{g}. The calculation is based on values including: a relative displacement amount X_{g} between the pipe and the ground at the fault surface where the fault displacement amount in the pipe axis direction, which is one of the fault displacement amounts, is halved; a joint expansion and contraction amount δ; a relative displacement amount y(x), expressed in Formula 15, between the pipe and the ground at the position x in the pipe axis direction relative to the fault surface; and a range of influence X in the pipe axis direction expressed in Formula 16. In Formula 17, the relative displacement δ_{g} is extremely small, and thus a value satisfying y≥δ_{gy} is employed so that evaluation indicating safety is obtained also when y<δ_{g} is satisfied.

$$\begin{matrix}y ( x ) = - \frac{δ}{L - δ} x + {X}_{g} & [ Formula 15 ] \\ X = \frac{L - δ}{δ} {X}_{g} & [ Formula 16 ] \\ f ( y ) = {k}_{2} y + ( {k}_{1} - {k}_{2} ) {δ}_{g} & [ Formula 17 ]\end{matrix}$$

Then, a fifth step is performed to calculate the axial force fₘₐₓ at the fault position by using Formula 18.

$${f}_{m a x} = {\int }_{0}^{X} f ( y ( x ) ) dx = \frac{{k}_{2} ( L - δ )}{2 δ} {X}_{g}^{2} + \frac{{δ}_{g} ( {k}_{1} - {k}_{2} ) ( L - δ )}{δ} {X}_{g} \qquad [ Formula 18 ]$$

Then, an axial force evaluation step is performed to evaluate the axial force based on whether the axial force fₘₐₓ obtained in the fifth step does not exceed a predetermined reference value. Preferably, the predetermined reference value is set based on 3 DkN (D=nominal diameter). Thus, the axial force resistance performance is evaluated for various fault displacements with different fault displacement amounts in the pipe orthogonal direction, only by using a fault displacement amount X_{g} in the pipe axis direction.

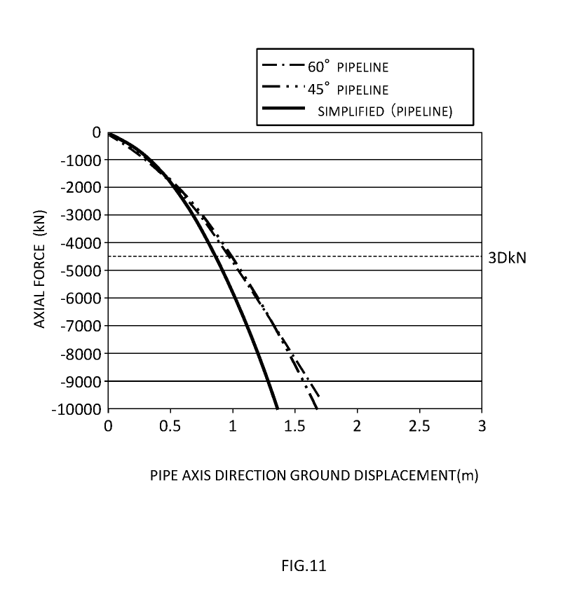

As illustrated in FIG. 11, comparison between results of the FEM analysis for the fault angles 45° and 60° (respectively represented by a one dot chained line and a two dot chained line in FIG. 11) and a result of the method according to present invention (represented by a solid line in FIG. 11) proves that a result of the evaluation indicating safety is obtained around the axial force 3 DkN, with the curves substantially matching in a low axial force range.

When the axial force fₘₐₓ is evaluated to exceed the predetermined reference value in the axial force evaluation step described above, a sixth step is performed. In the sixth step, as illustrated in FIG. 10C, a position where the deflection angle θ, obtained in the third step, does not exceed a predetermined angle threshold θₜ is determined as an arranged position of the large displacement absorption unit with a joint expansion and contraction amount (a long collar for the expansion and contraction amount) Δ (δ<<Δ). In FIG. 10C, the large displacement absorption unit is disposed in a section D-E so as not to exceed the angle threshold θₜ.

The large displacement absorption unit is a collar for achieving a displacement absorption amount larger than the displacement absorption amount achieved by a normal earthquake resistant joint, that is, a displacement absorption amount larger than the pipe joint expansion and contraction amount δ. The collar is an earthquake resistant joint pipe having sockets on both sides and having a length of approximately 1 to 3 m. Generally, the large displacement absorption unit is provided to the pipeline at an interval of 10 to 100 m, so as to be capable of effectively functioning. The pipeline is formed with the spigots of the pipes inserted in the sockets on both ends of the large displacement absorption unit.

The large displacement absorption units need to be disposed to sandwich a range of influence of the displacement in the pipe orthogonal direction, that is, a range in which the joints are deflected. Thus, specifically, the angle threshold θₜ is set to be sufficiently smaller than the angle θₐ resulting in an extremely large moment of the joint deflection spring illustrated in FIG. 7A, for the sake of safety. In the present embodiment, the angle θₐ is set to be 3.20, whereas the angle threshold θₜ is set to be 1°. The angle threshold θₜ is not limited to 1°, and may be set to be any appropriate value as long as the safety is ensured.

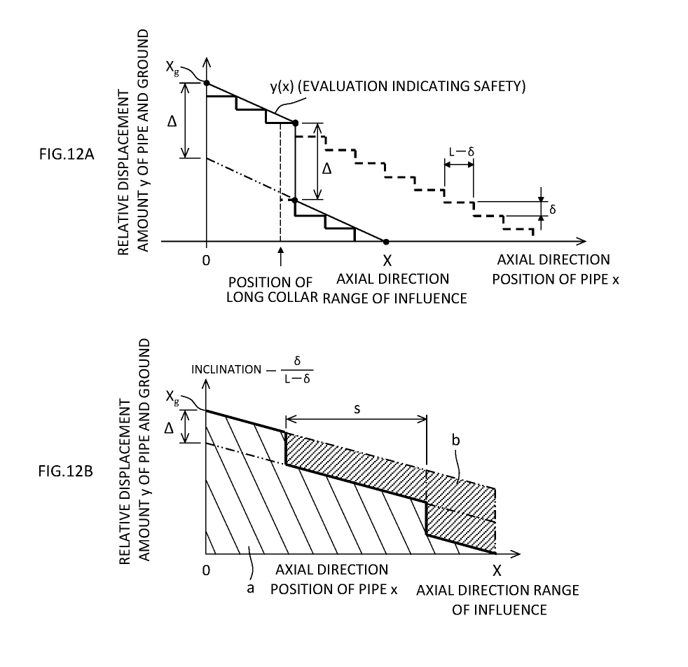

As illustrated in FIG. 12A, with the large displacement absorption units, the range of influence in the axis direction can be narrowed, and the relative displacement amount of the pipeline outside the large displacement absorption unit can be reduced. Thus, the axial force is reduced.

A seventh step is performed for calculating the axial force fₘₐₓ, for the range of influence X in the pipe axis direction defined by Formula 19, by using Formula 20. In Formula 19, s represents an arrangement interval of the large displacement absorption units and N_{g} represents the number of the large displacement absorption units within the range of influence in the pipe axis direction.

$$X = max ( \frac{L - δ}{δ} ( {X}_{g} - {N}_{g} Δ ) , {n}_{1} ( L - δ ) + ( {N}_{g} - 1 ) n ( L - δ ) ) \\ {N}_{g} = ⌈ \frac{{X}_{g} - {n}_{1} δ}{n δ + Δ} ⌉ , \\ {n}_{1} = ⌈ ( n + 1 ) / 2 ⌉ , \\ n = s / L \qquad [ Formula 19 ]$$

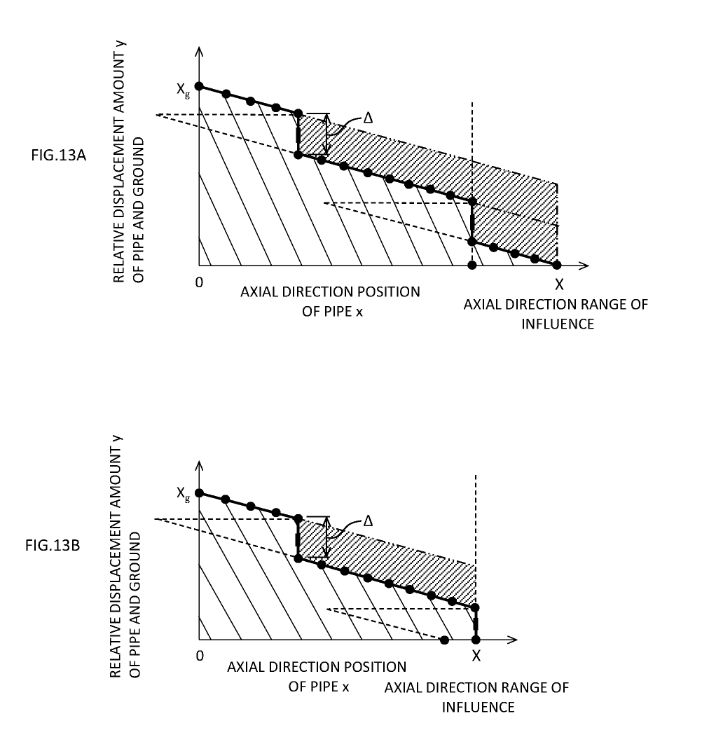

In the Formula (Formula 19), n₁ represents the number of joints in a range between the fault surface and the first large displacement absorption unit. The values N_{g} and n₁ are determined by a ceiling function that maps any real number to the maximum integer. A first half and a second half of the formula expressing the range of influence X respectively correspond to a case where the joints between the large displacement absorption units N_{g} and N_{g}+1 are contracted with the unit contracted as much as possible (see FIG. 13A), and a case where the unit N_{g} is contracted (see FIG. 13B).

$$\begin{matrix}{f}_{m a x} = {f}_{ab} - {f}_{b} & [ Formula 20 ] \\ {f}_{ab} = - \frac{{k}_{2} δ}{2 ( L - δ )} {X}^{2} + \{ {δ}_{g} ( {k}_{1} - {k}_{2} ) + {k}_{2} {X}_{g} \} X & \\ {f}_{b} = max ( 0 , \frac{{N}_{g} ( {N}_{g} - 1 )}{2} {f}_{b 1} ) + {f}_{b 2} {N}_{g} & \\ {f}_{b 1} = \{ {k}_{2} Δ + {δ}_{g} ( {k}_{1} - {k}_{2} ) \} n ( L - δ ) & \\ {f}_{b 2} = {f}_{b 1} \frac{X - {X}_{1}}{n ( L - δ )} & \\ {X}_{1} = {n}_{1} ( L - δ ) + ( {N}_{g} - 1 ) n ( L - δ ) & \end{matrix}$$

In the figure, f_{ab} represents the axial force produced due to the relative displacement in an area a+b illustrated in FIG. 12B, and f_{b} represents the axial force produced by the relative displacement in a range b. The axial force f_{b} is subtracted from the axial force f_{ab} so that fₘₐₓ is obtained.

Based on whether the axial force fₘₐₓ, obtained in the seventh step described above, does not exceed a predetermined reference value, a large displacement absorption unit absorbing axial force evaluation step for evaluating the axial fore is performed.

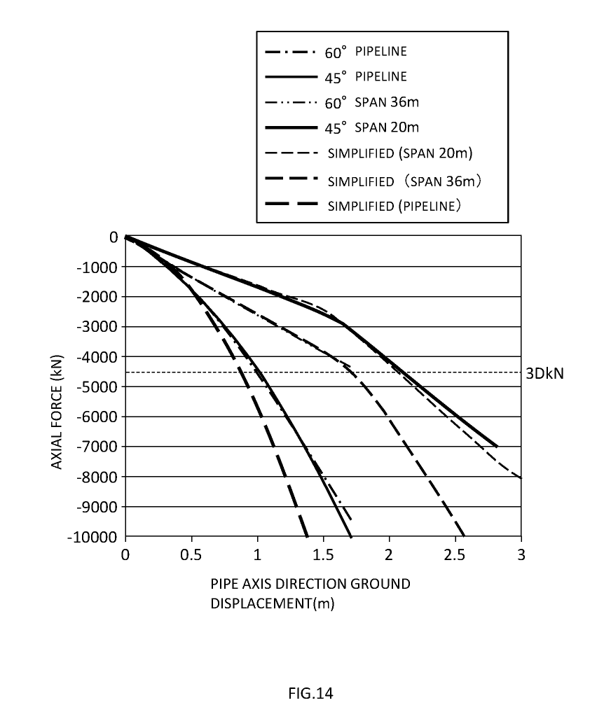

As illustrated in FIG. 14, it has been found that the result of the FEM analysis and the result of the axial force analysis described above substantially match.

Furthermore, an axial stress calculation step of calculating axial stress σₐ=fₘₐₓ/A from the axial force fₘₐₓ and a pipe cross-sectional area A is performed. A bending stress calculation step of calculating bending stress σ_{b}=M/Z from a bending moment M and a pipe section modulus Z is performed. A stress calculation step of calculating stress σ=σₐ+σ_{b} by adding the bending stress σ_{b}, obtained by the bending stress calculation, to the axial stress σₐ, obtained by the axial stress calculation is performed. A stress evaluation step of evaluating the stress based on whether the stress a obtained in the stress calculation step does not exceed a predetermined resistance is performed.

In the stress evaluation step, whether the stress does not exceed an allowable value is evaluated. The stress is obtained as the sum of the axial stress σₐ, calculated from the axial force fₘₐₓ and the pipe cross-sectional area A, and the bending stress σ_{b}, calculated from the bending moment M and the pipe section modulus Z.

After the pipeline is reviewed through such a simple analysis, the FEM analysis is finally performed. Thus, the reliability of the simple analysis is ensured. When the large displacement absorption unit is added, the interval of the large displacement absorption unit may be determined in advance through the simple analysis described above, and then the FEM analysis may be finally performed. Thus, the FEM analysis taking a long period of time needs not to be repeated for a large number of times.

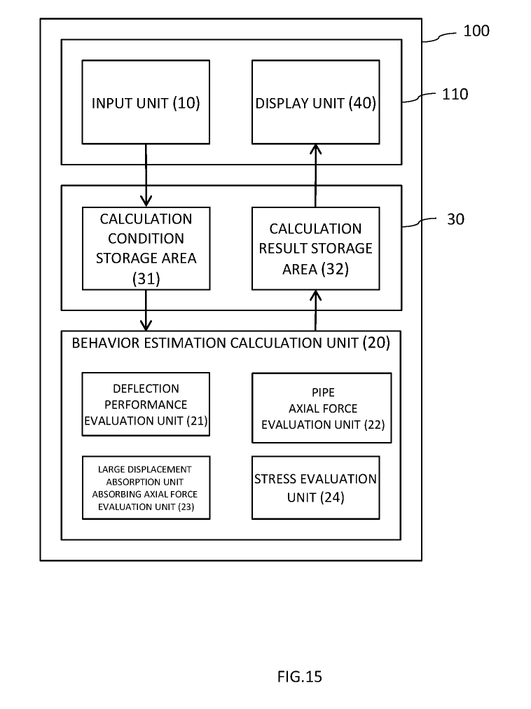

As illustrated in FIG. 15, a behavior estimation device 100 for a fault-crossing underground pipeline according to the present invention is a personal computer or the like having general spreadsheet software installed and including: a behavior estimation calculation unit 20 that performs the behavior estimation method for a fault-crossing underground pipeline described above; a condition input unit 10 for setting a calculation condition for the behavior estimation calculation unit 20; a storage unit 30 that stores the calculation condition input through the condition input unit 10 and a calculation result obtained by the behavior estimation calculation unit 20; and a display unit 40 that displays any of the calculation results stored in the storage unit 30. The condition input unit 10 and the display unit 40 are each implemented with a liquid crystal display device 110 having a touch panel function. The personal computer is connected to a printer, a media drive, and a portable memory interface, or the like serving as an output unit that outputs any of the calculation results stored in the storage unit 30.

More specifically, a calculation condition, for simulation, input to the condition input unit 10 includes values including: a fault intersecting angle φ, a nominal diameter D, an outer diameter D2, a pipe wall thickness t, and a pipe joint expansion and contraction amount δ of the pipe; a joint expansion and contraction amount Δ, a pipe length L, and a span s of the large displacement absorption units; an N value; and spring constants of various spring models; and the like. When these values are input, the deflection performance of various spring models and joints is uniquely determined through a predetermined calculation formula.

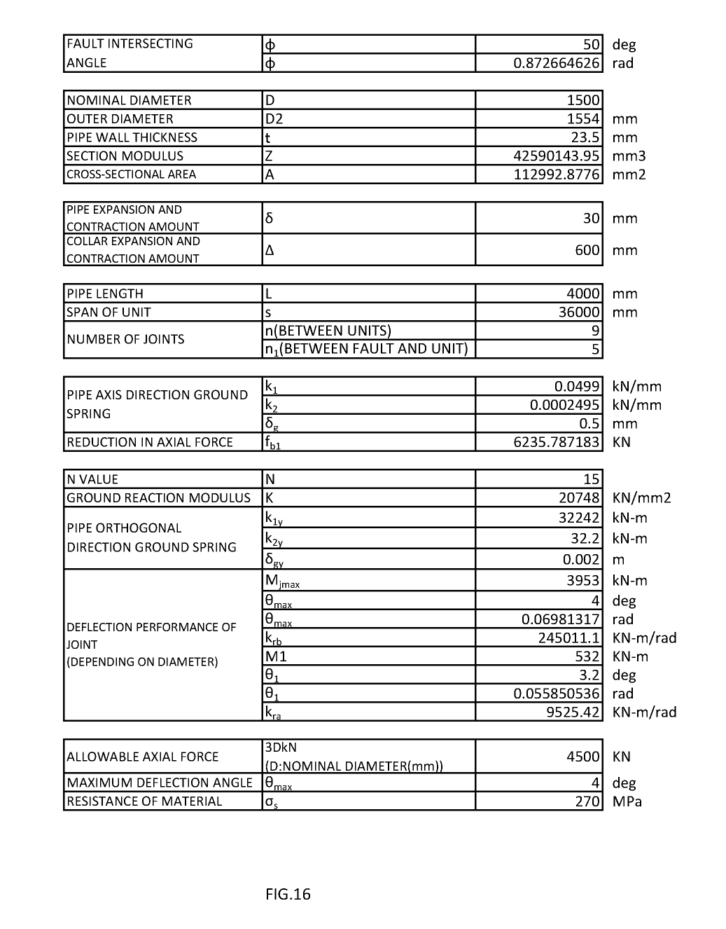

The calculation conditions are set and input by moving a cursor to an appropriate field in a data table, displayed on the liquid crystal display device 110, and inputting values using a keyboard or the like. FIG. 16 illustrates an example of a data table displayed on the liquid crystal display device 110.

The condition input unit 10 stores the calculation condition set to the data table in an input value storage area 31 defined in the storage unit 30.

When the input of various conditions on the condition input unit 10 is completed, the behavior estimation calculation unit 20 starts. The behavior estimation calculation unit 20 includes a deflection performance evaluation unit 21 that performs the deflection performance evaluation step described above, a pipe axial force evaluation unit 22 that performs the axial force evaluation step described above, a large displacement absorption unit absorbing axial force evaluation unit 23 that performs the large displacement absorption unit absorbing axial force evaluation step described above, and a stress evaluation unit 24 that performs the stress evaluation step described above.

The behavior estimation calculation unit 20 sets a fault displacement amount X_{f} based on interval increment (0.1 m in the present embodiment) set in advance to be within a range between 0 m and 4 m, for the fault intersecting angle φ input, and starts the deflection performance evaluation unit 21. A range of the fault displacement amount X_{f} and the interval increment are not limited to particular values, and may be set as appropriate.

The deflection performance evaluation unit 21 repeatedly performs the first step to the third step and the deflection performance evaluation step described above, by calculating a fault displacement amount H in the pipe orthogonal direction and a half value H/2 thereof using Formula (H=X_{f}/sin φ) based on the fault intersecting angle φ set and the fault displacement amounts X_{f}, and stores the results in a calculation result storage area.

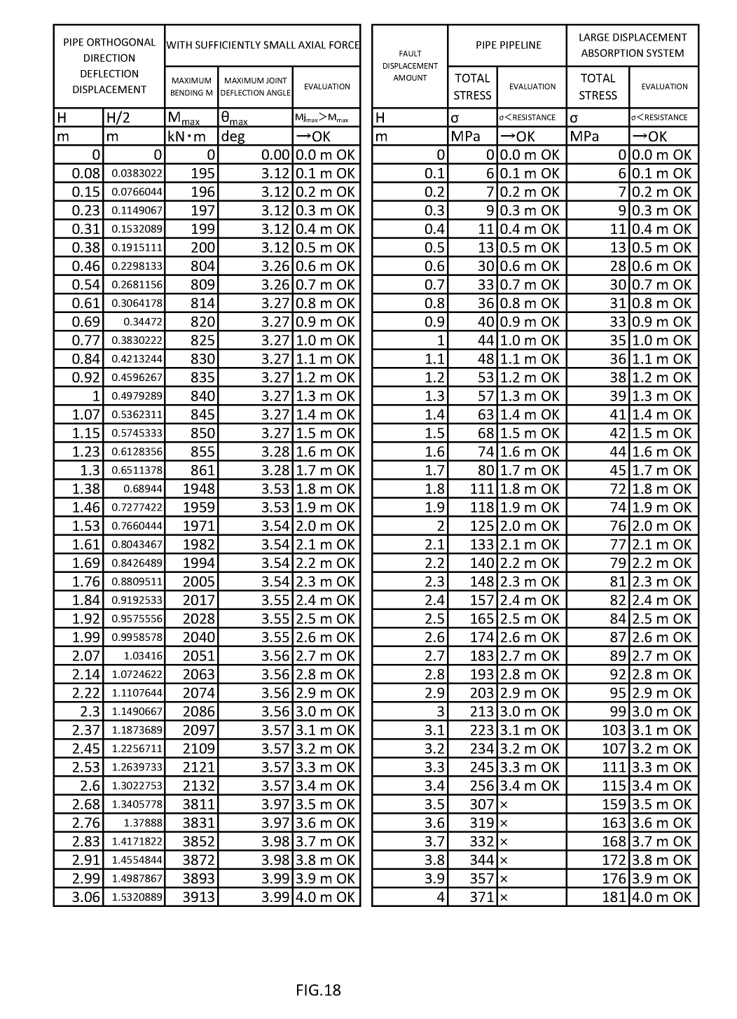

A left section of FIG. 18 illustrates the results of the deflection performance evaluation, displayed by the display unit 40. Thus, the deflection resistance performance is evaluated only based on the fault displacement amount X_{f} in the pipe orthogonal direction, for various fault displacements with different fault displacement amounts in the pipe axis direction.

The calculation is terminated at a timing when the deflection performance evaluation step results in negative evaluation result. When the undesirable result is thus obtained, the condition input unit 10 is restarted, the values of the pipe length L and the nominal diameter D are updated, and a similar evaluation process is performed based on a new calculation condition.

Similarly, the behavior estimation calculation unit 20 sets the fault displacement amount X_{f} based on interval increment (0.1 m in the present embodiment) set in advance to be within a range between 0 m and 4 m, for the fault intersecting angle φ input, and starts the pipe axial force evaluation unit 22.

The pipe axial force evaluation unit 22 repeatedly executes the fourth and the fifth steps and the axial force evaluation step described above, by calculating fault displacement amount X_{g} in the pipe axis direction using Formula (X_{g}=X_{f}·cos φ) based on the fault intersecting angle φ set and the fault displacement amounts X_{f}, and stores the results in the calculation result storage area.

When the axial force fₘₐₓ is evaluated to exceed the predetermined reference value before the expected fault displacement amount X_{f} is reached in the axial force evaluation step, a series of the following axial force evaluation step is terminated.

Then, the behavior estimation calculation unit 20 sets the fault displacement amount X_{f} based on interval increment (0.1 m in the present embodiment) set in advance to be within a range between 0 m and 4 m, for the fault intersecting angle φ input, and starts the large displacement absorption unit absorbing axial force evaluation unit 23.

The large displacement absorption unit absorbing axial force evaluation unit 23 executes the sixth step, the seventh step, and the large displacement absorption unit absorbing axial force evaluation step described above on the pipeline model including the large displacement absorption unit by calculating the fault displacement amount X_{g} in the pipe axis direction using Formula (X_{g}=X_{f}·cos φ) based on the fault intersecting angle φ set and the fault displacement amounts X_{f}.

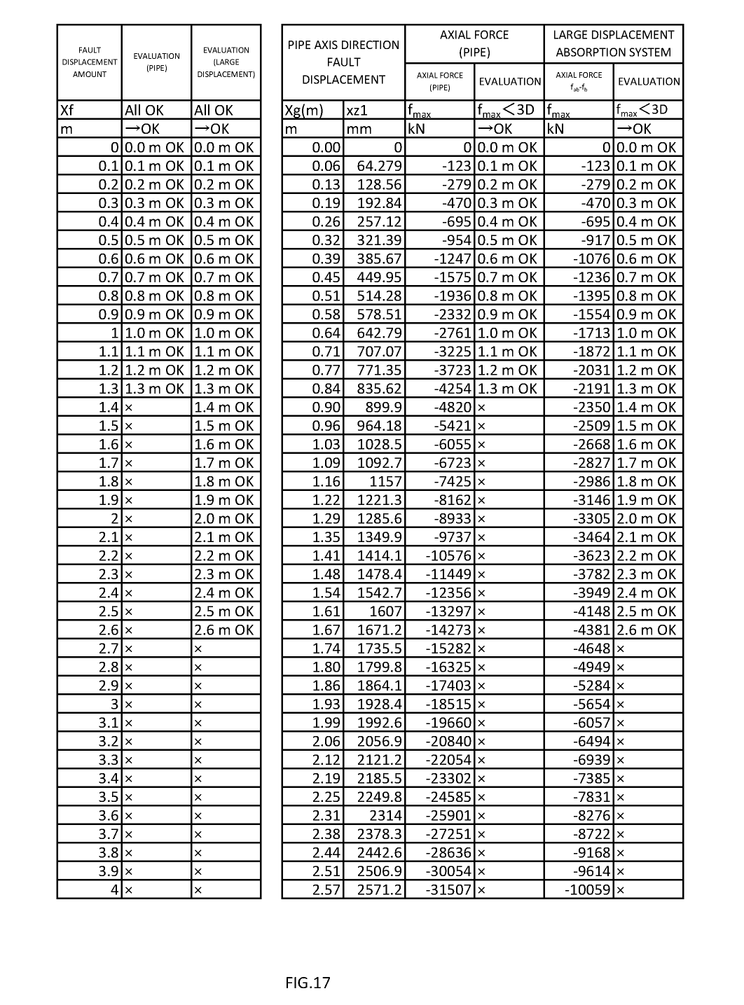

A right section in FIG. 17 illustrates the result of the pipe axial force evaluation and the result of the large displacement absorption unit absorbing axial force evaluation displayed by the display unit 40. Thus, the axial force resistance performance is evaluated for various fault displacements with different fault displacement amounts in the pipe orthogonal direction, only by using the fault displacement amount X_{g} in the pipe axis direction.

When the pipe axial force evaluation and the large displacement absorption unit absorbing axial force evaluation result in an evaluation result indicating an undesired performance, the condition input unit 10 is restarted, the values of the pipe length L, the nominal diameter D, the span s of the unit, and the like are updated, and a similar evaluation process is performed based on a new calculation condition.

Finally, the behavior estimation calculation unit 20 starts the stress evaluation unit 24. The stress evaluation unit 24 performs the axial stress calculation step, the bending stress calculation step, the stress calculation step, and the stress evaluation step described above, based on the evaluation results obtained by the deflection performance evaluation unit 21, the pipe axial force evaluation unit 22, and the large displacement absorption unit absorbing axial force evaluation unit 23. A right section of FIG. 18 illustrates the stress evaluation results displayed by the display unit 40.

When the evaluation by the stress evaluation unit 24 is terminated, the behavior estimation calculation unit 20 executes total evaluation on the pipeline model for the fault intersecting angle q) set and the fault displacement amounts X_{f}, and displays the result on the display unit 40. A left section of FIG. 17 illustrates total evaluation result. In this example, it can be apparently determined that when the fault intersecting angle is 50°, the joint performance can be ensured as long as the fault displacement amount in the pipeline model for the pipe does not exceed 1.3 m, and the joint performance can be ensured as long as the fault displacement amount in the pipeline model including the large displacement absorption unit does not exceed 1.6 m. The tables in each of FIG. 17 and FIG. 18 are displayed on a single screen so that values can be compared.

To absorb an even larger fault displacement amount, the simulation is performed again after updating any one of the values, as a calculation condition for simulation, through the condition input unit 10. The values include a nominal diameter D, an outer diameter D2, a pipe wall thickness t, and a pipe joint expansion and contraction amount δ of the pipe, a joint expansion and contraction amount Δ, a pipe length L, and a span s of the large displacement absorption units, an N value, and spring constants of various spring models, and the like.

When it is determined that the desired performance is not achieved based on the result displayed on the display unit 40, the condition input unit 10 is started again, and similar evaluation process is repeated based on a new calculation condition.

With the behavior estimation device 100 for a fault-crossing underground pipeline having the configuration described above, evaluation with a certain level of reliability can be performed within a short period of time without performing simulation calculation employing the finite element method requiring extremely long calculation time. Thus, the earthquake resistance of the pipeline that has been buried can be evaluated, and a pipeline that is planned to be laid with high earthquake resistance can be designed. The evaluation results as illustrated in FIG. 17 and FIG. 18 are output, by the printer, the media drive, the portable memory interface, or the like, as a document expressing earthquake resistance including an earthquake resistance evaluation document for a pipeline that has been laid and an earthquake resistance design document for a pipeline yet to be laid.

In other words, to make a general personal computer function as a behavior estimation device for a fault-crossing underground pipeline, a program is installed in the computer, the program causing the computer to perform a first step of calculating a minimum number of earthquake resistant joints N, on one side of a fault surface, required for absorbing a fault displacement amount H in a pipe orthogonal direction, in fault displacement amounts, based on an allowable deflection angle θₐ defined by a predetermined joint deflection spring model and a pipe effective length L, by using Formula 11, and calculating a deflection range L₀ in a pipe axis direction corresponding to the minimum number of earthquake resistant joints N by using Formula 12, a second step of calculating a load p(y), received by the pipe due to relative displacement y between the pipe and ground, as a trapezoidal distribution load by using Formula 13 for a ground spring model in the pipe orthogonal direction defined with spring constants k_{1y} and k_{2y} (k_{1y}>k_{2y}) of different values respectively for relative displacements smaller and larger than predetermined relative displacement δ_{gy}, a third step of calculating a bending moment distribution of joint positions from a bending moment M(x) of the trapezoidal distribution load at a position x in the pipe axis direction by using Formula 14, and obtaining a pipe deflection angle θ at each of the joint positions based on the joint deflection spring model using the bending moment distribution obtained, and a deflection performance evaluation step of evaluating deflection performance based on whether the deflection angle θ, obtained in the third step, does not exceed the allowable deflection angle θₐ.

The program also includes a fourth step of calculating axial force f(y) by using Formula 17 corresponding to the ground spring model in the pipe axis direction defined with spring constants k₁ and k₂ (k₁>k₂) respectively for relative displacements smaller and larger than predetermined relative displacement δ_{g}, based on a relative displacement amount X_{g} between the pipe and the ground at a fault surface corresponding to a half value of a fault displacement amount in the pipe axis direction, in the fault displacement amounts, a joint expansion and contraction amount δ, a relative displacement amount y(x), between the pipe and the ground at the position x in the pipe axis direction relative to the fault surface, defined with Formula 15, and a range of influence X, in the pipe axis direction, defined by Formula 16, a fifth step of calculating axial force fₘₐₓ at a fault position by using Formula 18, and an axial force evaluation step of evaluating the axial force based on whether the axial force fₘₐₓ obtained in the fifth step does not exceed a predetermined reference value.

The program also includes a sixth step of setting, when the axial force fₘₐₓ is evaluated to exceed the predetermined reference value in the axial force evaluation step, a arranged position of each of large displacement absorption units with a joint expansion and contraction amount Δ, the arranged position being a position where the deflection angle θ obtained in the third step does not exceed a predetermined angle threshold θₜ, a seventh step of calculating the axial force fₘₐₓ by using Formula 20 for the range of influence X, in the pipe axis direction, defined by Formula 19, and a large displacement absorption unit absorbing axial force evaluation step of evaluating the axial force based on whether the axial force fₘₐₓ obtained in the seventh step does not exceed a predetermined reference value.

The program also includes an axial stress calculation step of calculating axial stress σ=fₘₐₓ/A based on the axial force fₘₐₓ and a pipe cross-sectional area A, a bending stress calculation step of calculating bending stress σ_{b}=M/Z based on the bending moment M and a pipe section modulus Z, a stress calculation step of calculating stress σ=σₐ+σ_{b} by adding the axial stress σₐ obtained in the axial stress calculation step and the bending stress σ_{b} obtained in the bending stress calculation step, and a stress evaluation step of evaluating the stress based on whether the stress σ obtained in the stress calculation step does not exceed a predetermined resistance.

Such a program can be implemented with a general spreadsheet software, and can be implemented by using a macro instruction embedded in the spreadsheet software in advance for example.

Specifically, the behavior estimation device 100 for a fault-crossing underground pipeline includes an input unit 10 through which a calculation condition is input to be set, the deflection performance evaluation unit 21 that performs deflection performance evaluation processing, for evaluating performance at the time of the occurrence of fault, based on the calculation condition input through the input unit 10, and the display unit 40 that displays a table with which whether a positive evaluation or a negative evaluation is obtained as a result of the evaluation by the deflection performance evaluation unit 21 is visible, for the fault displacement amount in the pipe orthogonal direction.

The deflection performance evaluation unit 21 includes a first calculation unit that calculates a minimum number of earthquake resistant joints N, on one side of a fault surface, required for absorbing a fault displacement amount H in a pipe orthogonal direction, in fault displacement amounts, based on an allowable deflection angle θₐ defined by a predetermined joint deflection spring model and a pipe effective length L, by using Formula 11, and calculates a deflection range L₀ in a pipe axis direction corresponding to the minimum number of earthquake resistant joints N by using Formula 12, a second calculation unit that calculates a load p(y), received by the pipe due to relative displacement y between the pipe and ground, as a trapezoidal distribution load by using Formula 13 corresponding to a ground spring model in the pipe orthogonal direction defined with spring constants k_{1y} and k_{2y} (k_{1y}>k_{2y}) respectively for relative displacements smaller and larger than predetermined relative displacement δ_{gy}, a third calculation unit that calculates a bending moment distribution of joint positions from a bending moment M(x) of the trapezoidal distribution load at a position x in the pipe axis direction by using Formula 14, and obtains a pipe deflection angle θ at each of the joint positions based on the joint deflection spring model using the bending moment distribution obtained, and a deflection performance evaluation calculation unit that evaluates deflection performance based on whether the deflection angle θ, obtained by the third calculation unit, does not exceed the allowable deflection angle θₐ.

The deflection performance evaluation unit 21 is configured to make the first calculation unit to the third calculation unit repeatedly operate, for fault displacement amounts each obtained by being incremented by a predetermined pitch from the previous one, until the negative result is obtained by the deflection performance evaluation calculation unit.

The behavior estimation device 100 for a fault-crossing underground pipeline includes the input unit 10 through which a calculation condition is input to be set, the pipe axial force evaluation unit 22 that performs axial force evaluation processing, for evaluating performance at the time of the occurrence of fault, using a simple pipeline model including no large displacement absorption unit based on the calculation condition input through the input unit 10, and the display unit 40 that displays a table with which whether a positive evaluation or a negative evaluation is obtained as a result of the evaluation by the pipe axial force evaluation unit 22 is visible, for the fault displacement amount in the pipe axis direction.

The pipe axial force evaluation unit 22 includes a fourth calculation unit that calculates axial force f(y) by using Formula 17 corresponding to the ground spring model in the pipe axis direction defined with spring constants k₁ and k₂ (k₁>k₂) respectively for relative displacements smaller and larger than predetermined relative displacement δ_{g}, based on a relative displacement amount X_{g} between the pipe and the ground at a fault surface corresponding to a half value of a fault displacement amount in the pipe axis direction, in the fault displacement amounts, a joint expansion and contraction amount δ, a relative displacement amount y(x), between the pipe and the ground at the position x in the pipe axis direction relative to the fault surface, defined with Formula 15, and a range of influence X, in the pipe axis direction, defined by Formula 16, a fifth calculation unit that calculates axial force fₘₐₓ at a fault position by using Formula 18, and an axial force evaluation calculation unit that evaluates the axial force based on whether the axial force fₘₐₓ obtained by the fifth calculation unit does not exceed a predetermined reference value.

The pipe axial force evaluation unit 22 is configured to make the fourth calculation unit and the fifth calculation unit repeatedly operate, for fault displacement amounts each obtained by being incremented by a predetermined pitch from the previous one, until the negative result is obtained by the axial force evaluation calculation unit.

The behavior estimation device for a fault-crossing underground pipeline includes the input unit 10 through which a calculation condition is input to be set, the large displacement absorption unit absorbing pipe axial force evaluation unit 23 that performs axial force evaluation processing, for evaluating performance at the time of the occurrence of fault, using a combined pipeline model including the large displacement absorption units based on the calculation condition input through the input unit 10, and the display unit 40 that displays a table with which whether a positive evaluation or a negative evaluation is obtained as a result of the evaluation by the large displacement absorption unit absorbing pipe axial force evaluation unit 23 is visible, for the fault displacement amount in the pipe axis direction.

The large displacement absorption unit absorbing pipe axial force evaluation unit 23 includes a sixth calculation unit that is started when the axial force fₘₐₓ is evaluated to exceed the predetermined reference value by the pipe axial force evaluation unit 22, and sets an arranged position of each of large displacement absorption units with a joint expansion and contraction amount Δ, the arranged position being a position where the deflection angle θ obtained by the third calculation unit does not exceed a predetermined angle threshold θₜ, a seventh calculation unit that calculates the axial force fₘₐₓ by using Formula 20 for the range of influence X, in the pipe axis direction, defined by Formula 19 based on a disposed interval s of the large displacement absorption units, number N_{g} of the large displacement absorption units within the range of influence in the pipe axis direction, and number n₁ of joints between the fault surface and one of the large displacement absorption units closest to the fault surface, and a large displacement absorption unit absorbing axial force evaluation processing unit that evaluates the axial force based on whether the axial force fₘₐₓ obtained by the seventh calculation unit does not exceed a predetermined reference value.

The large displacement absorption unit absorbing pipe axial force evaluation unit 23 is configured to make the sixth calculation unit and the seventh calculation unit repeatedly operate, for fault displacement amounts each obtained by being incremented by a predetermined pitch from the previous one, until the negative result is obtained by the large displacement absorption unit absorbing axial force evaluation processing unit.

The behavior estimation device 100 for a fault-crossing underground pipeline includes an axial stress calculation unit that calculates axial stress σₐ=fₘₐₓ/A based on the axial force fₘₐₓ calculated by the pipe axial force evaluation unit 22 or the large displacement absorption unit absorbing axial force evaluation unit 23 and a pipe cross-sectional area A, a bending stress calculation unit that calculates bending stress σ_{b}=M/Z based on the bending moment M calculated by the deflection performance evaluation unit 21 and a pipe section modulus Z, a stress calculation unit that calculates stress σ=σₐ+σ_{b} by adding the axial stress σₐ obtained by the axial stress calculation unit and the bending stress σ_{b} obtained by the bending stress calculation unit, and a stress evaluation processing unit that evaluates the stress based on whether the stress σ obtained by the stress calculation unit does not exceed a predetermined resistance.

The display unit 40 is further provided that displays a table with which whether a positive evaluation or a negative evaluation is obtained as a result of the stress evaluation processing unit is visible, for the fault displacement amount.

As described above, in the behavior estimation device 100 for a fault-crossing underground pipeline, the deflection performance evaluation unit 21 that evaluates the pipeline model based on the ground displacement in the pipe orthogonal direction in the fault displacement amounts, the pipe axial force evaluation unit 22 that evaluates the pipeline model based on the ground displacement in the pipe axis direction in the fault displacement amounts, and the large displacement absorption unit absorbing axial force evaluation unit 23 can each be independently implemented. The stress evaluation unit 24 performs total evaluation based on the evaluation results obtained by these units. Furthermore, that output, onto a sheet of paper or an electronic recording medium, unit that outputs a positive evaluation result, obtained by each evaluation unit, as a document expressing earthquake resistance including an earthquake resistance evaluation document for a pipeline that has been laid and an earthquake resistance design document for a pipeline yet to be laid, through a printer, a media drive, a portable memory interface, or the like is provided. With a pipeline provided to have a pipeline configuration identified by the document expressing earthquake resistance obtained by the behavior estimation method for a fault-crossing underground pipeline as described above performed for a fault displacement of a predetermined fault displacement amount, a fault-crossing underground pipeline with resistance against fault displacement of a predetermined expected fault displacement amount in a pipe axis direction and/or a pipe orthogonal direction can be laid.

Thus, accurate evaluation can be achieved with sufficient calculation speed, due to large reduction of calculation loads from that in the FEM analysis for evaluation using a complex formula based on the fault displacement amount along a fault angle (p.

The input data display table illustrated in FIG. 16 is associated with a memory map set to calculation condition storage area 31 defined in the storage unit 30. The evaluation data display tables illustrated in FIG. 17 and FIG. 18 are associated with a memory map set to a calculation result storage area 32 defined in the storage unit 30. Thus, memory areas required for calculation and for displaying need not to be redundantly set, whereby a memory area can be efficiently used.

Such a behavior estimation device 100 for a fault-crossing underground pipeline can not only enable evaluation of the earthquake resistance of a pipeline that has been buried, but can also enable a planned pipeline to be laid to be designed with sufficient safety based on estimated behavior of this fault-crossing underground pipeline.

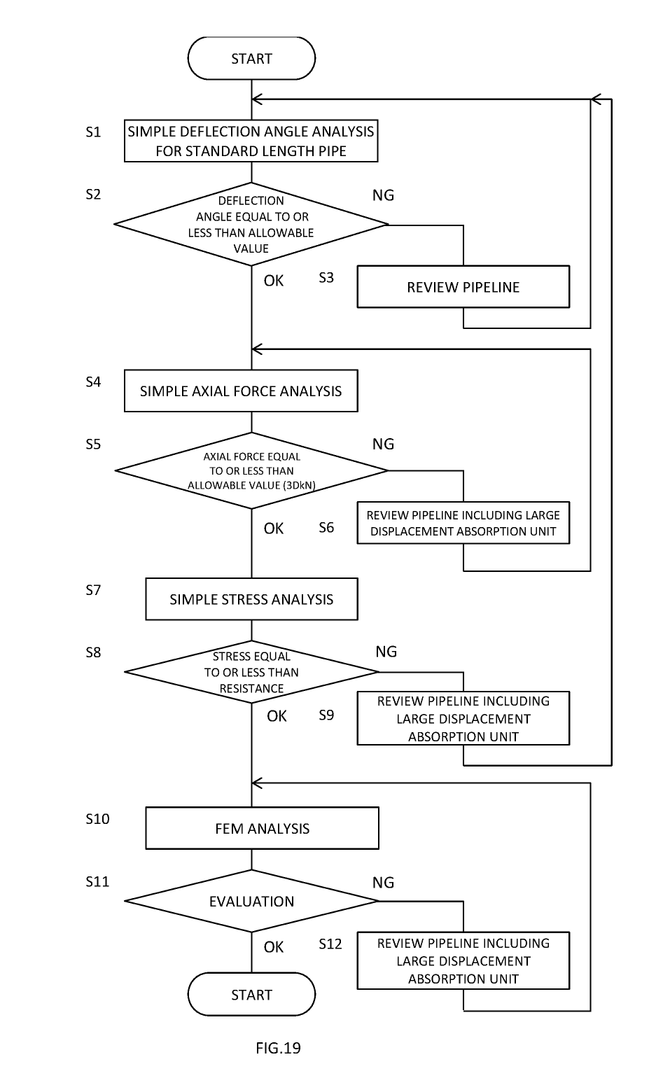

FIG. 19 illustrates a flow of behavior estimation using the behavior estimation device for a fault-crossing underground pipeline and a FEM analysis device. First of all, the behavior estimation device 100 performs simple analysis on a deflection angle of a standard length pipe (S1), evaluates the result (S2), and reviews the pipeline and performs the simple analysis on the deflection angle again when the result is NG (S3).

When the result of the simple analysis on the deflection angle is OK (S2), simple analysis on axial force is performed (S4), a result is evaluated (S5), and the pipeline is reviewed and the simple analysis on the axial force is performed again when the result is NG (S6).

When the result of the simple analysis on the axial force is OK (S5), simple analysis on stress is performed (S7), a result is evaluated (S8), and the pipeline is reviewed and the simple analysis in step S1 is performed again when the result is NG (S9).

When the result of the simple analysis on the stress is OK (S8), FEM analysis is performed (S10), a result is evaluated, the pipeline is reviewed, and the FEM analysis is performed again (S10) when the result is NG (S11). The analyses are terminated when the result is OK. As described above, the behavior estimation device 100 is used to perform the analyses in step S1 to step S9 repeatedly performed within a short period of time, and a desired result thus obtained is subjected to the FEM analysis. Thus, sufficiently reliable analysis can be achieved. With this configuration, the number of times the FEM analysis, which is a final and time consuming analysis, is repeated can be largely reduced. Thus, an environment for swifter evaluation operation can be achieved.

In the flowchart illustrated in FIG. 19, an example is illustrated where the FEM analysis in step S10 is performed after the desired evaluation result is obtained in all of the analyses in step S1, S4, and S7. Alternatively, the FEM analysis in step S10 may be performed after the desired evaluation result is obtained in any one of the simple analyses in steps S1, S4, and S7. Thus, the present invention may be applied to evaluate one of the deflection angle and the axial force, or may be applied to perform the FEM analysis after one of the deflection angle and the axial force is evaluated.

The above description is on one embodiment of a behavior estimation method for a fault-crossing underground pipeline and a behavior estimation device for a fault-crossing underground pipeline. Thus, the scope of the present invention is not limited by this description. The purpose variable and a coefficient of a category of the purpose variable are not limited to the type and the value described above, and can be changed as appropriate as long as the advantageous effects of the present invention is obtained.

1. A behavior estimation method for a fault-crossing underground pipeline, the method comprising:
a first step of calculating a minimum number of earthquake resistant joints N, on one side of a fault surface, required for absorbing a fault displacement amount H in a pipe orthogonal direction, in fault displacement amounts, by using Formula 1, and calculating a deflection range L₀ in a pipe axis direction corresponding to the minimum number of earthquake resistant joints N by using Formula 2, for a pipeline including joints defined with a predetermined joint deflection spring model with a bending moment set to be different values before and after an allowable bending angle θₐ and pipes having an effective length L,
$$\begin{matrix}\frac{H}{2} ≦ L {\sum }_{k = 1}^{N} sin ( k {θ}_{a} ) & [ Formula 1 ] \\ {L}_{0} = L \times N ; & [ Formula 2 ]\end{matrix}$$
a second step of calculating a load p(y), received by the pipe due to relative displacement y between the pipe and ground, as a trapezoidal distribution load by using Formula 3 corresponding to a ground spring model in the pipe orthogonal direction defined with spring constants k_{1y} and k_{2y} (k_{1y}>k_{2y}) respectively for relative displacements smaller and larger than predetermined relative displacement δ_{gy},
p(y)=k_{2y}y+(k_{1y}−k_{2y})δ_{gy}; [Formula 3]
a third step of calculating a bending moment distribution of joint positions from a bending moment M(x) of the trapezoidal distribution load at a position x in the pipe axis direction by using Formula 4, and obtaining a pipe bending angle θ at each of the joint positions based on the joint deflection spring model using the bending moment distribution obtained,
$$M ( x ) = \frac{x ( {L}_{0} - x )}{6} \{ 3 p ( 0 ) + ( \frac{2 {L}_{0} - x}{{L}_{0}} ) p ( \frac{H}{2} ) \} ; \qquad [ Formula 4 ]$$
a bending performance evaluation step of evaluating bending performance based on whether the bending angle θ, obtained in the third step, does not exceed the allowable bending angle θₐ; and
a bending performance output step of outputting an evaluation result when the bending angle θ does not exceed the allowable bending angle θₐ as a document expressing earthquake resistance indicating bending resistance performance, wherein
the bending resistance performance is able to be evaluated only based on the fault displacement amount H in the pipe orthogonal direction, for various fault displacements with different fault displacement amounts in the pipe axis direction.

2. The behavior estimation method for a fault-crossing underground pipeline according to claim 1 further comprising:
a fourth step of calculating axial force f(y) by using Formula 7 corresponding to the ground spring model in the pipe axis direction defined with spring constants k₁ and k₂ (k₁>k₂) respectively for relative displacements smaller and larger than predetermined relative displacement δ_{g}, based on a relative displacement amount X_{g} between the pipe and the ground at a fault surface corresponding to a half value of a fault displacement amount in the pipe axis direction, in the fault displacement amounts, a joint expansion and contraction amount δ, a relative displacement amount y(x), between the pipe and the ground at the position x in the pipe axis direction relative to the fault surface, defined with Formula 5, and a range of influence X, in the pipe axis direction, defined by Formula 6,
$$\begin{matrix}y ( x ) = - \frac{δ}{L - δ} x + {X}_{g} , & [ Formula 5 ] \\ X = \frac{L - δ}{δ} {X}_{g} , and & [ Formula 6 ] \\ f ( y ) = {k}_{2} y + ( {k}_{1} - {k}_{2} ) {δ}_{g} ; & [ Formula 7 ]\end{matrix}$$
a fifth step of calculating axial force fₘₐₓ at a fault position by using Formula 8,
$${f}_{m a x} = {\int }_{0}^{X} f ( y ( x ) ) dx = \frac{{k}_{2} ( L - δ )}{2 δ} {X}_{g}^{2} + \frac{{δ}_{g} ( {k}_{1} - {k}_{2} ) ( L - δ )}{δ} {X}_{g} ; \qquad [ Formula 8 ]$$
an axial force evaluation step of evaluating the axial force based on whether the axial force fₘₐₓ obtained in the fifth step does not exceed a predetermined reference value; and
an axial force performance output step of outputting an evaluation result when the axial force fₘₐₓ obtained in the fifth step does not exceed the predetermined reference value as a document expressing earthquake resistance indicating axial force resistance for a pipe connecting pipeline, wherein
axial force resistance performance is able to be evaluated for various fault displacements with different fault displacement amounts in the pipe orthogonal direction, only by using a fault displacement amount X_{g} in the pipe axis direction.

3. The behavior estimation method for a fault-crossing underground pipeline according to claim 2 further comprising:
a sixth step of setting, when the axial force fₘₐₓ is evaluated to exceed the predetermined reference value in the axial force evaluation step, a arranged position of each of large displacement absorption units with a joint expansion and contraction amount Δ, the arranged position being a position where the bending angle θ obtained in the third step does not exceed a predetermined angle threshold θₜ;
a seventh step of calculating the axial force fₘₐₓ by using Formula 10 for the range of influence X, in the pipe axis direction, defined by Formula 9 based on a disposed interval s of the large displacement absorption units, number N_{g} of the large displacement absorption units within the range of influence in the pipe axis direction, and number n₁ of joints between the fault surface and one of the large displacement absorption units closest to the fault surface,
$$\begin{matrix}X = max ( \frac{L - δ}{δ} ( {X}_{g} - {N}_{g} Δ ) , {n}_{1} ( L - δ ) + ( {N}_{g} - 1 ) n ( L - δ ) ) \\ {N}_{g} = ⌈ \frac{{X}_{g} - {n}_{1} δ}{n δ + Δ} ⌉ , \\ {n}_{1} = ⌈ ( n + 1 ) / 2 ⌉ , \\ n = s / L & [ Formula 9 ] \\ \begin{matrix}{f}_{m a x} = {f}_{ab} - {f}_{b} \\ {f}_{ab} = - \frac{{k}_{2} δ}{2 ( L - δ )} {X}^{2} + \{ {δ}_{g} ( {k}_{1} - {k}_{2} ) + {k}_{2} {X}_{g} \} X \\ {f}_{b} = max ( 0 , \frac{{N}_{g} ( {N}_{g} - 1 )}{2} {f}_{b 1} ) + {f}_{b 2} {N}_{g} \\ {f}_{b 1} = \{ {k}_{2} Δ + {δ}_{g} ( {k}_{1} - {k}_{2} ) \} n ( L - δ ) \\ {f}_{b 2} = {f}_{b 1} \frac{X - {X}_{1}}{n ( L - δ )} \\ {X}_{1} = {n}_{1} ( L - δ ) + ( {N}_{g} - 1 ) n ( L - δ ) ;\end{matrix} & [ Formula 10 ]\end{matrix}$$
a large displacement absorption unit absorbing axial force evaluation step of evaluating the axial force based on whether the axial force fₘₐₓ obtained in the seventh step does not exceed a predetermined reference value; and
an output step of outputting an evaluation result when the axial force fₘₐₓ obtained in the seventh step does not exceed the predetermined reference value as a document expressing earthquake resistance indicating axial force resistance for a pipe connecting pipeline including the large displacement absorption units.

4. The behavior estimation method for a fault-crossing underground pipeline according to claim 2 further comprising:
an axial stress calculation step of calculating axial stress σₐ=fₘₐₓ/A based on the axial force fₘₐₓ and a pipe cross-sectional area A;
a bending stress calculation step of calculating bending stress σ_{b}=M/Z based on the bending moment M and a pipe section modulus Z;
a stress calculation step of calculating stress σ=σₐ+σ_{b} by adding the axial stress σₐ obtained in the axial stress calculation step and the bending stress σ_{b} obtained in the bending stress calculation step;
a stress evaluation step of evaluating the stress based on whether the stress σ obtained in the stress calculation step does not exceed a predetermined resistance; and
an output step of outputting an evaluation result when the stress σ obtained in the stress calculation step does not exceed the predetermined resistance as a document expressing earthquake resistance indicating resistance for a pipe connecting pipeline.

5. The behavior estimation method for a fault-crossing underground pipeline according to claim 3 further comprising:
an axial stress calculation step of calculating axial stress σₐ=fₘₐₓ/A based on the axial force fₘₐₓ and a pipe cross-sectional area A;
a bending stress calculation step of calculating bending stress σ_{b}=M/Z based on the bending moment M and a pipe section modulus Z;
a stress calculation step of calculating stress σ=σₐ+σ_{b} by adding the axial stress σₐ obtained in the axial stress calculation step and the bending stress σ_{b} obtained in the bending stress calculation step;
a stress evaluation step of evaluating the stress based on whether the stress σ obtained in the stress calculation step does not exceed a predetermined resistance; and
an output step of outputting an evaluation result when the stress σ obtained in the stress calculation step does not exceed the predetermined resistance as a document expressing earthquake resistance indicating resistance for a pipe connecting pipeline including large displacement absorption units.

6. A behavior estimation method for a fault-crossing underground pipeline, the method comprising:
a simple analysis executing step of executing the behavior estimation method for a fault-crossing underground pipeline according to claim 1;
a detailed analysis executing step of executing a structural analysis method employing a finite element method after predetermined evaluation is obtained by the simple analysis executing step.

7. A method for laying a fault-crossing underground pipeline with resistance against fault displacement of a predetermined expected fault displacement amount in a pipe axis direction and/or a pipe orthogonal direction, the method comprising
laying a pipeline to have a pipeline configuration identified by the document expressing earthquake resistance obtained by the behavior estimation method for a fault-crossing underground pipeline according to claim 1 for a fault displacement of the predetermined fault displacement amount.

8. A behavior estimation device for a fault-crossing underground pipeline, the device comprising:
a behavior estimation calculation unit that executes the behavior estimation method for a fault-crossing underground pipeline, the behavior estimation calculation unit including a bending performance evaluation unit that executes
a first step of calculating a minimum number of earthquake resistant joints N, on one side of a fault surface, required for absorbing a fault displacement amount H in a pipe orthogonal direction, in fault displacement amounts, by using Formula 1, and calculating a bending range L₀ in a pipe axis direction corresponding to the minimum number of earthquake resistant joints N by using Formula 2, for a pipeline including joints defined with a predetermined joint deflection spring model with a bending moment set to be different values before and after an allowable bending angle θₐ and pipes having an effective length L,
$$\begin{matrix}\frac{H}{2} ≦ L {\sum }_{k = 1}^{N} sin ( k {θ}_{a} ) & [ Formula 1 ] \\ {L}_{0} = L \times N ; & [ Formula 2 ]\end{matrix}$$
a second step of calculating a load p(y), received by the pipe due to relative displacement y between the pipe and ground, as a trapezoidal distribution load by using Formula 3 corresponding to a ground spring model in the pipe orthogonal direction defined with spring constants k_{1y} and k_{2y} (k_{1y}>k_{2y}) respectively for relative displacements smaller and larger than predetermined relative displacement δ_{gy},
p(y)=k_{2y}y+(k_{1y}−k_{2y})δ_{gy}; [Formula 3]
a third step of calculating a bending moment distribution of joint positions from a bending moment M(x) of the trapezoidal distribution load at a position x in the pipe axis direction by using Formula 4, and obtaining a pipe bending angle θ at each of the joint positions based on the joint deflection spring model using the bending moment distribution obtained,
$$M ( x ) = \frac{x ( {L}_{0} - x )}{6} \{ 3 p ( 0 ) + ( \frac{2 {L}_{0} - x}{{L}_{0}} ) p ( \frac{H}{2} ) \} ; \qquad [ Formula 4 ]$$
and
a bending performance evaluation step of evaluating bending performance based on whether the bending angle θ, obtained in the third step, does not exceed the allowable bending angle θₐ;
a condition input unit with which a calculation condition is set for the behavior estimation calculation unit;
a storage unit that stores calculation results obtained by the behavior estimation calculation unit;
a display unit that displays any one of the calculation results stored in the storage unit; and
an output unit that outputs a positive evaluation result stored in the storage unit as a document expressing earthquake resistance.

9. The behavior estimation device for a fault-crossing underground pipeline according to claim 8, wherein the behavior estimation calculation unit includes an axial force evaluation unit that executes
a fourth step of calculating axial force f(y) by using Formula 7 corresponding to the ground spring model in the pipe axis direction defined with spring constants k₁ and k₂ (k₁>k₂) respectively for relative displacements smaller and larger than predetermined relative displacement δ_{g}, based on a relative displacement amount X_{g} between the pipe and the ground at a fault surface corresponding to a half value of a fault displacement amount in the pipe axis direction, in the fault displacement amounts, a joint expansion and contraction amount δ, a relative displacement amount y(x), between the pipe and the ground at the position x in the pipe axis direction relative to the fault surface, defined with Formula 5, and a range of influence X, in the pipe axis direction, defined by Formula 6,
$$\begin{matrix}y ( x ) = - \frac{δ}{L - δ} x + {X}_{g} , & [ Formula 5 ] \\ X = \frac{L - δ}{δ} {X}_{g} , and & [ Formula 6 ] \\ f ( y ) = {k}_{2} y + ( {k}_{1} - {k}_{2} ) {δ}_{g} ; & [ Formula 7 ]\end{matrix}$$
a fifth step of calculating axial force fₘₐₓ at a fault position by using Formula 8,
$${f}_{m a x} = {\int }_{0}^{X} f ( y ( x ) ) dx = \frac{{k}_{2} ( L - δ )}{2 δ} {X}_{g}^{2} + \frac{{δ}_{g} ( {k}_{1} - {k}_{2} ) ( L - δ )}{δ} {X}_{g} ; \qquad [ Formula 8 ]$$
and
an axial force evaluation step of evaluating the axial force based on whether the axial force fₘₐₓ obtained in the fifth step does not exceed a predetermined reference value.

10. The behavior estimation device for a fault-crossing underground pipeline according to claim 8, wherein
the behavior estimation calculation unit includes a large displacement absorption unit absorbing axial force evaluation unit that executes
a sixth step of setting, when the axial force fₘₐₓ is evaluated to exceed the predetermined reference value in the axial force evaluation step, a arranged position of each of large displacement absorption units with a joint expansion and contraction amount Δ, the arranged position being a position where the bending angle θ obtained in the third step does not exceed a predetermined angle threshold θₜ;
a seventh step of calculating the axial force fₘₐₓ by using Formula 10 for the range of influence X, in the pipe axis direction, defined by Formula 9 based on a disposed interval s of the large displacement absorption units, number N_{g} of the large displacement absorption units within the range of influence in the pipe axis direction, and number n₁ of joints between the fault surface and one of the large displacement absorption units closest to the fault surface,
$$\begin{matrix}X = max ( \frac{L - δ}{δ} ( {X}_{g} - {N}_{g} Δ ) , {n}_{1} ( L - δ ) + ( {N}_{g} - 1 ) n ( L - δ ) ) \\ {N}_{g} = ⌈ \frac{{X}_{g} - {n}_{1} δ}{n δ + Δ} ⌉ , \\ {n}_{1} = ⌈ ( n + 1 ) / 2 ⌉ , \\ n = s / L & [ Formula 9 ] \\ \begin{matrix}{f}_{m a x} = {f}_{ab} - {f}_{b} \\ {f}_{ab} = - \frac{{k}_{2} δ}{2 ( L - δ )} {X}^{2} + \{ {δ}_{g} ( {k}_{1} - {k}_{2} ) + {k}_{2} {X}_{g} \} X \\ {f}_{b} = max ( 0 , \frac{{N}_{g} ( {N}_{g} - 1 )}{2} {f}_{b 1} ) + {f}_{b 2} {N}_{g} \\ {f}_{b 1} = \{ {k}_{2} Δ + {δ}_{g} ( {k}_{1} - {k}_{2} ) \} n ( L - δ ) \\ {f}_{b 2} = {f}_{b 1} \frac{X - {X}_{1}}{n ( L - δ )} \\ {X}_{1} = {n}_{1} ( L - δ ) + ( {N}_{g} - 1 ) n ( L - δ ) ;\end{matrix} & [ Formula 10 ]\end{matrix}$$
and
a large displacement absorption unit absorbing axial force evaluation step of evaluating the axial force based on whether the axial force fₘₐₓ obtained in the seventh step does not exceed a predetermined reference value.

11. The behavior estimation device for a fault-crossing underground pipeline according to claim 8, wherein
the behavior estimation calculation unit includes a stress evaluation unit that executes
an axial stress calculation step of calculating axial stress σₐ=fₘₐₓ/A based on the axial force fₘₐₓ and a pipe cross-sectional area A;
a bending stress calculation step of calculating bending stress σ_{b}=M/Z based on the bending moment M and a pipe section modulus Z;
a stress calculation step of calculating stress σ=σₐ+σ_{b} by adding the axial stress σₐ obtained in the axial stress calculation step and the bending stress σ_{b} obtained in the bending stress calculation step; and
a stress evaluation step of evaluating the stress based on whether the stress σ obtained in the stress calculation step does not exceed a predetermined resistance.
